(19) United States
(12) Patent Application Publication
(10) Pub. No.: US 2013/0155209 A1
(43) Pub. Date: Jun. 20, 2013

(54) EYEWEAR DEVICE, DISPLAY DEVICE, VIDEO SYSTEM WITH EYEWEAR AND DISPLAY DEVICES, AND CONTROL METHODS OF EYEWEAR DEVICE AND VIDEO SYSTEM

(71) Applicant: PANASONIC CORPORATION, Osaka (JP)

(72) Inventor: Yoshihiro HARA, Osaka (JP)

(73) Assignee: PANASONIC CORPORATION, Osaka (JP)

(21) Appl. No.: 13/671,932

(22) Filed: Nov. 8, 2012

Related U.S. Application Data
(63) Continuation of application No. PCT/JP2012/001858, filed on Mar. 16, 2012.
(60) Provisional application No. 61/453,731, filed on Mar. 17, 2011.
(60) Provisional application No. 61/453,717, filed on Mar. 17, 2011.

(51) Int. Cl. G02B 27/22; H04N 13/04

(52) U.S. Cl. 348/55; 359/466; 348/E13.059

(57) ABSTRACT

The present application discloses an eyewear device, including: a light amount adjuster configured to perform an adjustment operation for adjusting a fluctuation timing, at which a transmission amount of image light to a left eye and a right eye increases or decreases, and allowing a video to be perceived stereoscopically; a storage portion configured to store characteristic data about the adjustment operation; a receiver configured to receive a synchronous control signal which defines the fluctuation timing; and a first controller configured to control the light amount adjuster. The first controller corrects the fluctuation timing defined by the synchronous control signal, based on the characteristic data to control the adjustment operation.

### TECHNICAL FIELD

The present invention relates to video technologies for allowing an observer to view a stereoscopic video appropriately.

### BACKGROUND ART

Domestic display devices capable of displaying 3D videos have been developed and commercialized (see Patent Documents 1 to 5) as 3D movies have become popular. A typical 3D video display device adopts the frame sequential scheme (i.e., time-divisional scheme). The display device alternately displays a left frame image, which is viewed by the left eye, and a right frame image, which is viewed by the right eye.

Projectors used in movie theaters, domestic television devices and display devices of personal computers are exemplified as the display device adopting the frame sequential scheme or time-divisional scheme. These 3D display devices alternately display left and right frame images.

An observer uses an eyewear device (generally called “3D active shutter eyeglasses”) to observe a video displayed on a 3D display device. The eyewear device includes a left shutter situated in front of the left eye of the observer and a right shutter situated in front of the right eye. A transmission amount of image light to the left and right eyes fluctuate in response to opening/closing operations of the left and right shutters.

A display device transmits synchronous control signals in synchronization with display of left and/or right frame images. For example, infrared (IR) signals or radio (RF) signals are used as the synchronous control signals. Once the eyewear device receives the synchronous control signals, the eyewear device opens the left shutter and closes the right shutter in synchronization with display of the left frame image. The eyewear device opens the right shutter and closes the left shutter in synchronization with the right frame image. Consequently, image light from the left frame image is transmitted only to the left eye whereas image light from the right frame image is transmitted only to the right eye.

Response characteristics of the shutters to the synchronous control signals may be different every eyewear device. For instance, it may take a period of “X1” for a certain eyewear device (“eyewear device A,” hereinafter) to open or close the right shutter after reception of a synchronous control signal for opening or closing the right shutter. On the other hand, it may take a period of “X2,” which is shorter or longer than “X1,” for another eyewear device (“eyewear device B,” hereinafter) to open or close the right shutter after reception of a synchronous control signal for opening or closing the right shutter. With regard to the left shutter as well, the required response time to the synchronous control signal may be different between the eyewear devices A and B.

If there is a difference in model between the eyewear devices A and B, for example, designing differences between the eyewear devices A and B may cause the aforementioned difference in the response period. Even if the eyewear devices A and B are the same model, for example, variation in characteristics of elements used in the shutters may cause the aforementioned difference in the response period.

Patent Document 1: U.S. Patent Application Publication No. 2011/0228215

Patent Document 2: U.S. Patent Application Publication No. 2011/0043753

Patent Document 3: U.S. Patent Application Publication No. 2011/0181708

Patent Document 4: U.S. Patent Application Publication No. 2011/0242293

Patent Document 5: U.S. Patent Application Publication No. 2010/0295929

### SUMMARY OF THE INVENTION

An object of the present invention is to provide video technologies capable of adjusting fluctuation timings to increase or decrease a transmission amount of image light to the left and right eyes in response to operational characteristics of the eyewear device.

The eyewear device according to one aspect of the present invention includes a light amount adjuster configured to perform an adjustment operation for adjusting a fluctuation timing, at which a transmission amount of image light to a left eye and a right eye increases or decreases, and allowing a video to be perceived stereoscopically; a storage portion configured to store characteristic data about the adjustment operation; a receiver configured to receive a synchronous control signal which defines the fluctuation timing; and a first controller configured to control the light amount adjuster. The first controller corrects the fluctuation timing defined by the synchronous control signal, based on the characteristic data to control the adjustment operation.

The display device according to another aspect of the present invention includes: a display portion configured to display a video which is perceived stereoscopically, by means of a left frame image observed by a left eye and a right frame image observed by a right eye; a second controller configured to determine display timings, at which the left and right frame images are displayed, and cause the display portion to sequentially display the left and right frame images at the display timings; and a control signal transceiver configured to transmit a synchronous control signal for notifying an eyewear device of the display timing under control of the second controller. The eyewear device performs an adjustment operation for adjusting a fluctuation timing, at which a transmission amount of image light to the left and right eyes increases or decreases, and allowing the video to be perceived stereoscopically. The control signal transceiver receives characteristic data about the adjustment operation from the eyewear device. The second controller controls transmission of the synchronous control signal in response to the display timings and the characteristic data.

The video system according to another aspect of the present invention includes: an eyewear device configured to perform an adjustment operation for adjusting a fluctuation timing, at which a transmission amount of image light to a left eye and a right eye increases or decreases, and allowing a video to be perceived stereoscopically; and a display device configured to display the video by means of a left frame image observed by the left eye and a right frame image observed by the right eye. The display device includes a transmitter configured to transmit a synchronous control signal which defines the fluctuation timing. The eyewear device includes a light amount adjuster configured to perform the adjustment operation; a storage portion configured to store characteristic data about the adjustment operation; a receiver configured to receive the synchronous control signal; and a first controller configured to control the light amount adjuster. The first controller corrects the fluctuation timing defined by the synchronous control signal based on the characteristic data to control the adjustment operation.

The video system according to yet another aspect of the present invention includes: an eyewear device configured to perform an adjustment operation for adjusting a fluctuation timing, at which a transmission amount of image light to a left eye and a right eye increases or decreases, and allowing a video to be perceived stereoscopically; and a display device configured to display the video by means of a left frame image observed by the left eye and a right frame image observed by the right eye. The eyewear device includes a light amount adjuster configured to execute the adjustment operation; a storage portion configured to store characteristic data about the adjustment operation; a data transceiver configured to transmit the characteristic data to the display device; and a first controller configured to control the light amount adjuster. The display device includes: a display portion configured to display the video; a second controller configured to determine display timings, at which the left and right frame images are displayed, and cause the display portion to sequentially display the left and right frame images at the display timings; and a control signal transceiver configured to receive the characteristic data and transmit a synchronous control signal for notifying the data transceiver of the display timings under control of the second controller. The second controller controls transmission of the synchronous control signal, based on the display timings and the characteristic data. The first controller controls the light amount adjuster in response to the synchronous control signal.

The control method according to yet another aspect of the present invention is applied to an eyewear device configured to perform an adjustment operation for adjusting a fluctuation timing, at which a transmission amount of image light to the left and right eyes increases or decreases, and allowing a video to be perceived stereoscopically. The control method includes steps of: receiving a synchronous control signal which defines the fluctuation timing; and correcting the fluctuation timing defined by the synchronous control signal, based on characteristic data about the adjustment operation, to control the adjustment operation.

The control method according to yet another aspect of the present invention is applied to a video system, which includes an eyewear device configured to perform an adjustment operation for adjusting a fluctuation timing, at which a transmission amount of image light to the left and right eyes increases or decreases, and allowing a video to be perceived stereoscopically, and a display device configured to display the video by means of a left frame image observed by the left eye and a right frame image observed by the right eye. The control method has steps of transmitting characteristic data about the adjustment operation from the eyewear device to the display device; determining display timings at which the left and right frame images are displayed; controlling transmission of a synchronous control signal for notifying the eyewear device of the display timing, based on the display timings and the characteristic data; and adjusting the fluctuation timing in response to the synchronous control signal.

The present invention may adjust a fluctuation timing, at which a transmission amount of image light to the left and right eyes of an observer increases or decreases, in response to operational characteristics of an eyewear device.

The objects, features and advantages of the present invention will become apparent from the following detailed description and the accompanying drawings.

### BRIEF DESCRIPTION OF THE DRAWINGS

FIG. 1 is a schematic perspective view of an eyewear device according to the first embodiment.

FIG. 2 is a schematic timing chart showing response characteristics of a general eyewear device.

FIG. 3 is a schematic block diagram showing a hardware configuration of the eyewear device depicted in FIG. 1.

FIG. 4 is a schematic view of a measurement system for acquiring characteristic data stored in the eyewear device shown in FIG. 3.

FIG. 5A is a schematic graph showing characteristic data measured by the measurement system depicted in FIG. 4.

FIG. 5B is a schematic graph showing characteristic data measured by the measurement system depicted in FIG. 4.

FIG. 6 is a schematic block diagram showing a functional configuration of the eyewear device shown in FIG. 3.

FIG. 7 is a schematic block diagram showing a hardware configuration of a display device used with the eyewear device depicted in FIG. 3.

FIG. 8 is a schematic block diagram showing a functional configuration of the display device depicted in FIG. 7.

FIG. 9 is a schematic table showing processes to which synchronous control signals are subjected by a controller of the eyewear device depicted in FIG. 6.

FIG. 10 is a schematic graph showing reference data created by the controller of the eyewear device depicted in FIG. 6.

FIG. 11 is a schematic table showing characteristic data stored in a storage portion of the eyewear device depicted in FIG. 6.

FIG. 12 is a graph schematically showing correction processes performed by the controller of the eyewear device depicted in FIG. 6.

FIG. 13 is a schematic view showing a video system having the eyewear device shown in FIG. 6.

FIG. 14 is a schematic flowchart showing a control method of the eyewear device shown in FIG. 6.

FIG. 15 is a schematic block diagram showing a functional configuration of an eyewear device according to the second embodiment.

FIG. 16 is a table schematically showing characteristic data stored in a storage portion of the eyewear device depicted in FIG. 15.

FIG. 17 is a graph schematically showing correction processes performed by a controller of the eyewear device depicted in FIG. 15.

FIG. 18 is a schematic block diagram showing a functional configuration of an eyewear device according to the third embodiment.

FIG. 19 is a schematic graph showing a relationship between a power supply period and a temperature of a driver of the eyewear device shown in FIG. 18.

FIG. 20 is a schematic block diagram showing a functional configuration of a display device according to the fourth embodiment.

FIG. 21 is a schematic view of a video system having the display device shown in FIG. 20.

FIG. 22 is a schematic view showing a packet structure used in communication between the display device and an eyewear device of the video system depicted in FIG. 21.

FIG. 23 is a schematic block diagram showing a functional configuration of the eyewear device of the video system depicted in FIG. 21.

FIG. 24A is a table showing characteristic data stored in a storage portion of the eyewear device depicted in FIG. 23.

FIG. 24B is a schematic graph showing an operation speed of a light amount adjuster of the eyewear device depicted in FIG. 23.

FIG. 25A is a table showing characteristic data stored in the storage portion of the eyewear device depicted in FIG. 23.

FIG. 25B is a schematic graph showing an operation speed of the light amount adjuster of the eyewear device depicted in FIG. 23.

FIG. 26 is a schematic view showing data string structures created by a controller of the eyewear device depicted in FIG. 23.

FIG. 27 is a schematic timing chart showing correction to timings of a period, during which a light transmission amount to the left or right eye is increased.

FIG. 28 is a schematic flowchart showing a control method of the video system depicted in FIG. 21.

FIG. 29 is a schematic block diagram showing a functional configuration of an eyewear device according to the fifth embodiment.

FIG. 30 is a schematic view of a video system having the eyewear device shown in FIG. 29.

FIG. 31 is a schematic block diagram showing a functional configuration of a display device of the video system depicted in FIG. 30.

FIG. 32 is a schematic flowchart showing a control method of the video system shown in FIG. 30.

### DETAILED DESCRIPTION OF THE INVENTION

Exemplary video technologies are described with reference to the accompanying drawings. It should be noted that configurations, arrangements shapes and alike, which are shown in the drawings, as well as relevant descriptions to the drawings, are intended to make principles of the video technologies easily understood. Therefore, the principles of the video technologies should not be limited to the following detailed description in any way.

### First Embodiment

### Eyewear Device

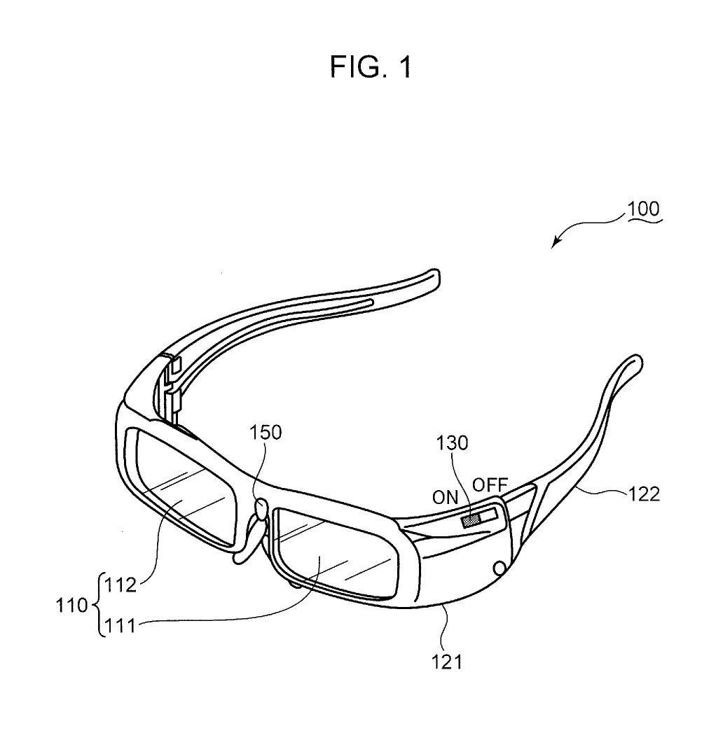

FIG. 1 is a schematic perspective view of the eyewear device 100 according to the first embodiment. The eyewear device 100 is described with reference to FIG. 1.

The eyewear device 100 includes a shutter portion 110 configured to adjust a light transmission amount to the left or right eye of an observer. The shutter portion 110 includes a left shutter 111 situated in front of the left eye of the observer and a right shutter 112 situated in front of the right eye of the observer.

While a display device (described hereinafter) displays a left frame image, which is observed by the left eye, the left shutter 111 is opened whereas the right shutter 112 is closed. Consequently, a large amount of image light reaches the left eye whereas few amounts of the image light reach the right eye. Thus, the observer observes the left frame image mainly with the left eye.

While the display device displays a right frame image, which is observed by the right eye, the left shutter 111 is closed whereas the right shutter 112 is opened. Consequently, few amounts of image light reach the left eye whereas a large amount of the image light reaches the right eye. Thus, the observer observes the right frame image mainly with the right eye.

The observer synthesizes the left and right frame images in the brain, for example, if the left and right frame images are displayed alternately on the display device and if the left and right shutters 111, 112 are opened/closed in synchronization with the left and right frame images as described above. Since there is a positional difference between objects depicted in the left and right frame images, the observer may perceive a video displayed on a display screen so that the object comes out from the display screen or recedes into the display screen by the positional difference (i.e., the observer stereoscopically perceives the video displayed on the display device).

As described above, the left shutter 111 matches a fluctuation timing, at which a transmission amount of image light to the left eye increases and decreases, to a display period of the left frame image (left frame period). The right shutter 112 matches a fluctuation timing, at which a transmission amount of image light to the right eye increases and decrease, to a display period of the right frame image (right frame period). Consequently, the observer may stereoscopically perceive the video displayed on the display device. In the following description, the adjustment to the fluctuation timings by means of the shutter portion 110 is referred to as “adjustment operation.” In the present embodiment, the shutter portion 110 is exemplified as the light amount adjuster.

The adjustment operation by the shutter portion 110 is controlled in response to synchronous control signals transmitted from the display device. The eyewear device 100 includes a receiving device 150 configured to receive the synchronous control signals. In the present embodiment, the synchronous control signals may be infrared signals or radio signals. In the present embodiment, the receiving device 150 is exemplified as the receiver.

The display device transmits the synchronous control signals in order to notify the eyewear device 100 of display start timings of left and/or right frame images. When the eyewear device 100 opens the left shutter 111 in synchronization with display start of the left frame image in response to the synchronous control signal, the observer may observe the left frame image appropriately. When the eyewear device 100 opens the right shutter 112 in synchronization with the display start of the right frame image in response to the synchronous control signal, the observer may observe the right frame image appropriately. In the present embodiment, the synchronous control signals are used for defining display timings of frame images.

In the present embodiment, fluctuation timings defined by the synchronous control signals entirely depend on display timings of left and/or right frame images. Response characteristics of the eyewear device 100 to the synchronous control signals are affected by inherent performance of the eyewear device 100 or an environment in which the eyewear device 100 is used (i.e., thermal environment, remaining power level, etc.). Therefore, if the adjustment operation by the shutter portion 110 is significantly affected by the response characteristics of the eyewear device 100, an observer may not observe left and/or right frame images at an appropriate time even if a display device transmits the synchronous control signals appropriately. The principles of the present embodiment contribute to compensation for effects of variance or fluctuation in the response characteristics of the shutter portion 110 of the eyewear device 100 on the adjustment operation.

The eyewear device 100 includes a frame portion 121, which supports the shutter portion 110, and arms 122, which extend from the frame portion 121 toward the ears of an observer. Therefore, the observer may wear the eyewear device 100 like typical vision correction eyeglasses. Accordingly, the left shutter 111 is situated in front of the left eye whereas the right shutter 112 is situated in front of the right eye.

The eyewear device 100 further includes a switch device 130 configured to control power supply to the shutter portion 110. When an observer sets the switch device 130 to “ON position”, power is supplied to various elements (described hereinafter) of the eyewear device 100. When the observer sets the switch device 130 to “OFF position”, the power supply to the various elements of the eyewear device 100 is stopped. Therefore, the observer may prevent unnecessary power consumption by means of the switch device 130.

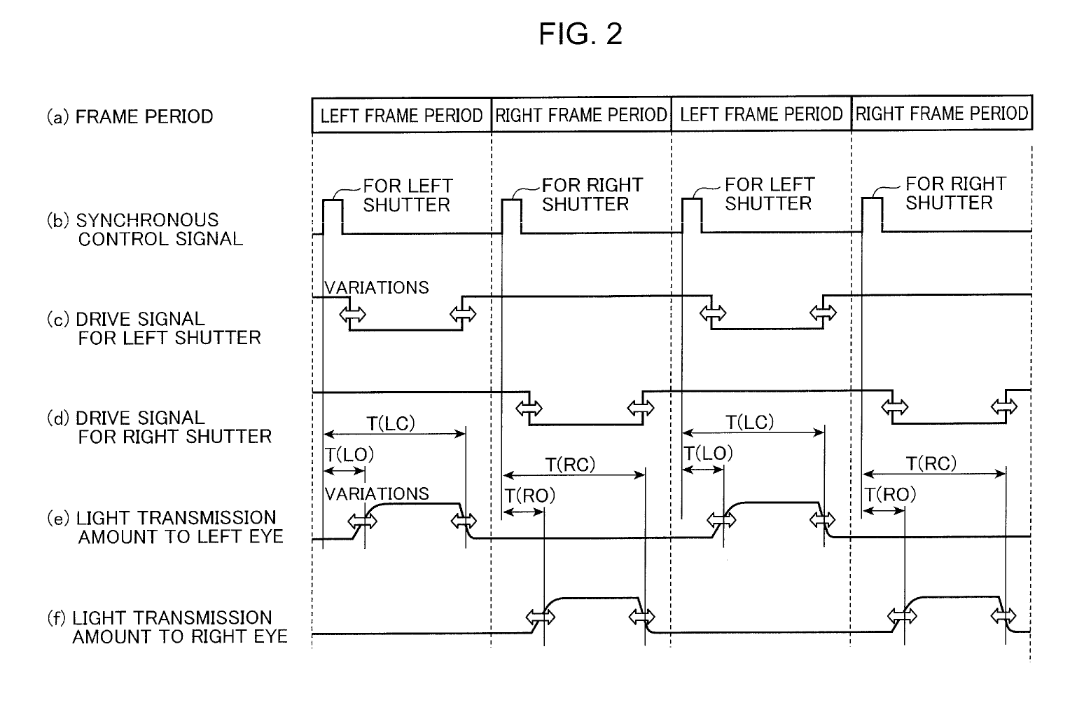

FIG. 2 is a schematic timing chart showing response characteristics of a general eyewear device. Variations and fluctuations in the response characteristics of the eyewear device are described with reference to FIGS. 1 and 2.

Section (a) of FIG. 2 shows a left frame period assigned as a display period of a left frame image, and a right frame period assigned as a display period of a right frame image. The left and right frame periods are assigned alternately.

Section (b) of FIG. 2 shows synchronous control signals transmitted from the display device. The synchronous control signal for operating the left shutter is transmitted in synchronization with the start of the left frame period. The synchronous control signal for operating the right shutter is transmitted in synchronization with the start of the right frame period.

Section (c) of FIG. 2 shows a drive signal for driving the left shutter. Section (d) of FIG. 2 shows a drive signal for driving the right shutter.

Timings at which the left and right shutters open/close depend on fluctuation timings at which voltage levels of the drive signals change. The voltage level of the drive signal for the left shutter drops after the eyewear device receives a synchronous control signal for the left shutter. After a predetermined period passes, the voltage level of the drive signal for left shutter increases. The voltage level of the drive signal for the right shutter drops after the eyewear device receives a synchronous control signal for the right shutter. After a predetermined period passes, the voltage level of the drive signal for the right shutter rises.

Section (e) of FIG. 2 shows a fluctuation in light transmission amount to the left eye. The fluctuation in the light transmission amount to the left eye represents the adjustment operation by the left shutter. The adjustment operation by the left shutter depends on the fluctuation in voltage level of the drive signal for the left shutter. For instance, if the voltage level of the drive signal drops, the left shutter starts opening. In section (e) shown in FIG. 2, “T (LO)” represents a time period from a rise of a synchronous control signal for the left shutter to when the light transmission amount to the left eye increases up to 50% of the maximum light transmission amount to the left eye. When the voltage level of the drive signal increases, the left shutter starts closing. The symbol “T (LC)” represents a time period from a rise of a synchronous control signal for the left shutter to when the light transmission amount to the left eye decreases to 50% of the maximum light transmission amount to the left eye. While the voltage level of the drive signal is low, the left shutter is opened to increase the transmission amount of image light to the left eye.

Timings at which the left shutter opens/closes are affected by shutter materials, designing differences between eyewear devices, and variances resulting from manufacturing processes of eyewear devices. In addition, it is known that operational characteristics of liquid crystal used in a typical left shutter are susceptible to an environmental temperature under which an eyewear device is used or a power amount (power supply voltage value) stored in the eyewear device.

Section (f) of FIG. 2 shows a fluctuation in light transmission amount to the right eye. The fluctuation in the light transmission amount to the right eye represents the adjustment operation by the right shutter. The adjustment operation by the right shutter depends on a fluctuation in voltage level of the drive signal for the right shutter. For instance, when the voltage level of the drive signal drops, the right shutter starts opening. Symbol “T (RO)” represents a time period from a rise of a synchronous control signal for the right shutter to when the light transmission amount to the right eye increases up to 50% of the maximum light transmission amount to the right eye. When the voltage level of the drive signal increases, the right shutter starts closing. The symbol “T (RC)” represents a time period from a rise of a synchronous control signal for the right shutter to when the light transmission amount to the right eye decreases to 50% of the maximum light transmission amount to the right eye. While the voltage level of the drive signal is low, the right shutter is opened to increase the light transmission amount to the right eye.

Timings at which the right shutter opens/closes are affected by shutter materials, designing differences between eyewear devices, and variances resulting from manufacturing processes of eyewear devices. In addition, it is known that operational characteristics of liquid crystal used in a typical right shutter are susceptible to an environmental temperature under which an eyewear device is used or a power amount (power supply voltage value) stored in the eyewear device.

As described above, the adjustment operation by the eyewear device is susceptible to various factors. Various elements (described hereinafter) of the eyewear device 100 described with reference to FIG. 1 reduce variance in a time period, which is required to increase or decrease a light transmission amount to the left or right eye to 50% from a rise of a synchronous control signal, by means of characteristic data which represent a relationship between the adjustment operation by the shutter portion 110 and influential factors to the adjustment operation.

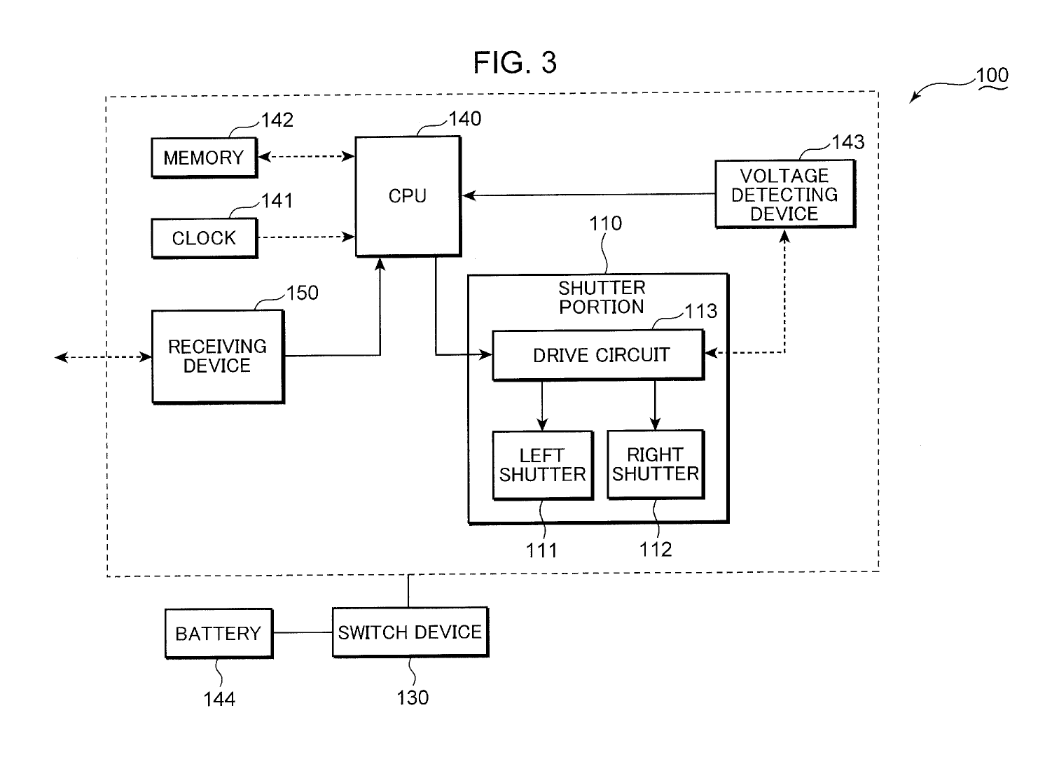

FIG. 3 is a schematic block diagram showing a hardware configuration of the eyewear device 100. The hardware configuration of the eyewear device 100 is described with reference to FIG. 3.

The eyewear device 100 includes the shutter portion 110, the switch device 130 and the receiving device 150 as described above. In addition to the left and right shutters 111, 112, the shutter portion 110 includes a drive circuit 113 configured to drive these. While the display device displays a left frame image, the drive circuit 113 adjusts a voltage magnitude applied to the left and right shutters 111, 112 to open the left shutter 111 and close the right shutter 112. While the display device displays a right frame image, the drive circuit 113 adjusts a voltage magnitude applied to the left and right shutters 111, 112 to close the shutter 111 and open the right shutter 112.

The eyewear device 100 further includes a CPU 140 configured to control the drive circuit 113. Synchronous control signals received from the display device are output from the receiving device 150 to the CPU 140. If the display device transmits infrared signals as the synchronous control signals, the receiving device 150 converts the infrared signals into electrical signals. The receiving device 150 then outputs the electrical signals to the CPU 140. If the display device transmits radio signals as the synchronous control signals, the receiving device 150 converts the radio signals into a readable format for the CPU 140. The converted signals are output to the CPU 140.

The CPU 140 controls the drive circuit 113 in response to synchronous control signals acquired through the receiving device 150. The drive circuit 113 may drive the left and right shutters 111, 112 under control of the CPU 140 in synchronization with display operation by the display device. In the present embodiment, the CPU 140 is exemplified as the first controller.

The eyewear device 100 further includes a clock 141 configured to output temporal information to the CPU 140. The CPU 140 may determine reception times, at which synchronous control signals are received, in response to the time data output from the clock 141. The CPU 140 may carry out averaging processes on the reception times at which synchronous control signals with the same waveform are received. The CPU 140 may determine times to open/close the left and right shutters 111, 112 in response to data about the averaged reception times.

The eyewear device 100 further includes a memory 142 configured to store data about reception times at which synchronous control signals are received. The memory 142 also stores characteristic data about the aforementioned adjustment operation. The CPU 140 determines times for opening/closing the left and right shutters 111, 112 with reference to the characteristic data stored in the memory 142. In the present embodiment, the memory 142 is exemplified as the storage portion.

The eyewear device 100 also includes a voltage detecting device 143 configured to detect a voltage magnitude for power supply to the drive circuit 113. Data about the magnitude for power supply to the drive circuit is output from the voltage detecting device 143 to the CPU 140. In the present embodiment, the characteristic data stored in the memory 142 represent a relationship between a voltage magnitude for power supply to the drive circuit 113 and a response speed (operation speed) of the left and/or right shutters 111, 112. The characteristic data are described hereinafter.

The eyewear device 100 also includes a battery 144. Power stored in the battery 144 is supplied to the shutter portion 110, the CPU 140, the clock 141, the memory 142, the voltage detecting device 143 and the receiving device 150 via the switch device 130. An observer may operate the switching device 130 to control power supply from the battery 144 to these elements. In the present embodiment, the battery 144 is exemplified as the power supply portion.

The power amount stored in the battery 144 affects a voltage magnitude at the drive circuit 113. Therefore, a voltage magnitude detected by the voltage detecting device 143 represents a power amount stored in the battery 144. In the present embodiment, the voltage detecting device 143 is exemplified as the power detector. In the present embodiment, the voltage magnitude detected by the voltage detecting device 143 is handled as the power amount stored in the battery 144. However, the power amount stored in the battery may be measured directly. Alternatively, another variable amount representing the power amount of the battery may be detected.

The power stored in the battery 144 is consumed for the adjustment operation by the shutter portion 110. Consequently, the power amount in the battery 144 gradually decreases. In the present embodiment, an operation speed of the left and right shutters 111, 112 drops as the power amount of the battery 144 decreases. The characteristic data stored in the memory 142 represent a tendency of the operation speed of the shutter portion 110 that slows down with the decrease in power amount of the battery 144. The CPU 140 compares the characteristic data stored in the memory 142 with the data about the voltage magnitude output from the voltage detecting device 143, and determines timings for increasing and decreasing a transmission amount of image light to the left and right eyes. A method for determining the timings is described hereinafter.

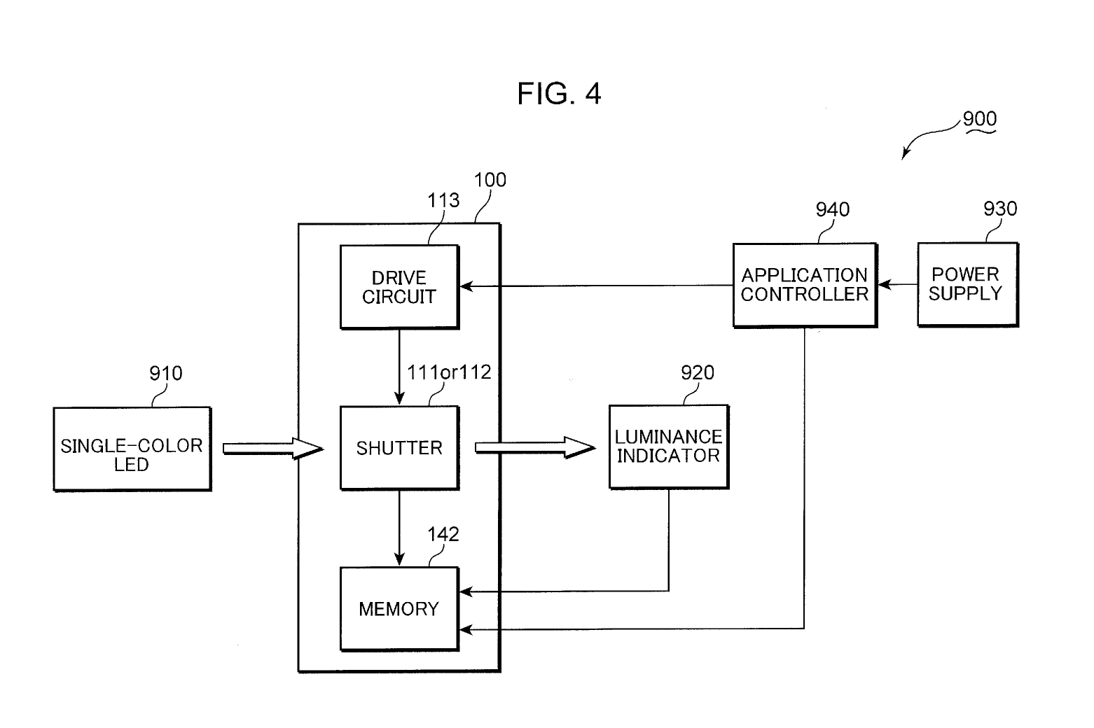

FIG. 4 is a schematic view of a measurement system 900 for acquiring the characteristic data. A method for acquiring the characteristic data is described with reference to FIG. 4.

The measurement system 900 includes a single-color LED 910, which emits light toward the left or right shutter 111, 112 of the eyewear device 100, and a luminance indicator 920, which measures luminance of light transmitted to the left or right shutter 111, 112. The luminance indicator 920 outputs data about the measured luminance and time period data to the memory 142 of the eyewear device 100.

The measurement system 900 also includes a power supply 930, which supplies power to the drive circuit 113 of the eyewear device 100, and an application controller 940, which controls a voltage applied to the drive circuit 113. The power supply 930 may change a level of the voltage applied to the drive circuit 113. The application controller 940 adjusts voltage application timings from the power supply 930 to the drive circuit 113. Data about a voltage applied from the power supply 930 as well as the time period data are output from the application controller 940 to the memory 142 of the eyewear device 100. It should be noted that the time period data output from the application controller 940 are coincident with the time period data output from the luminance indicator 920.

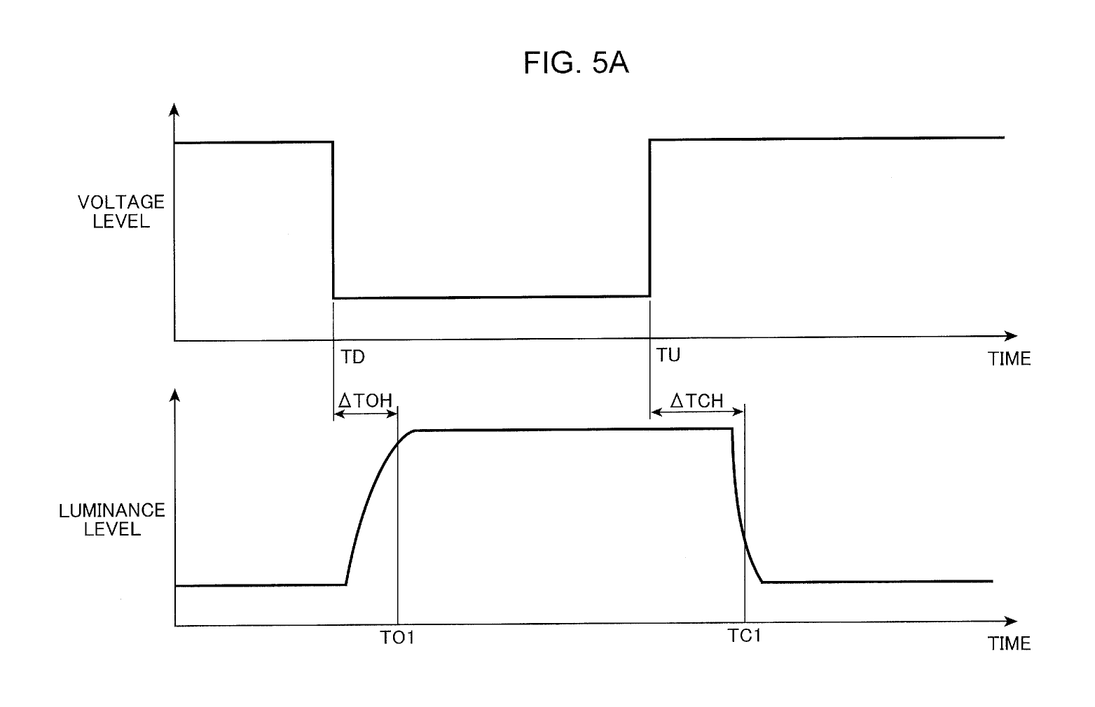

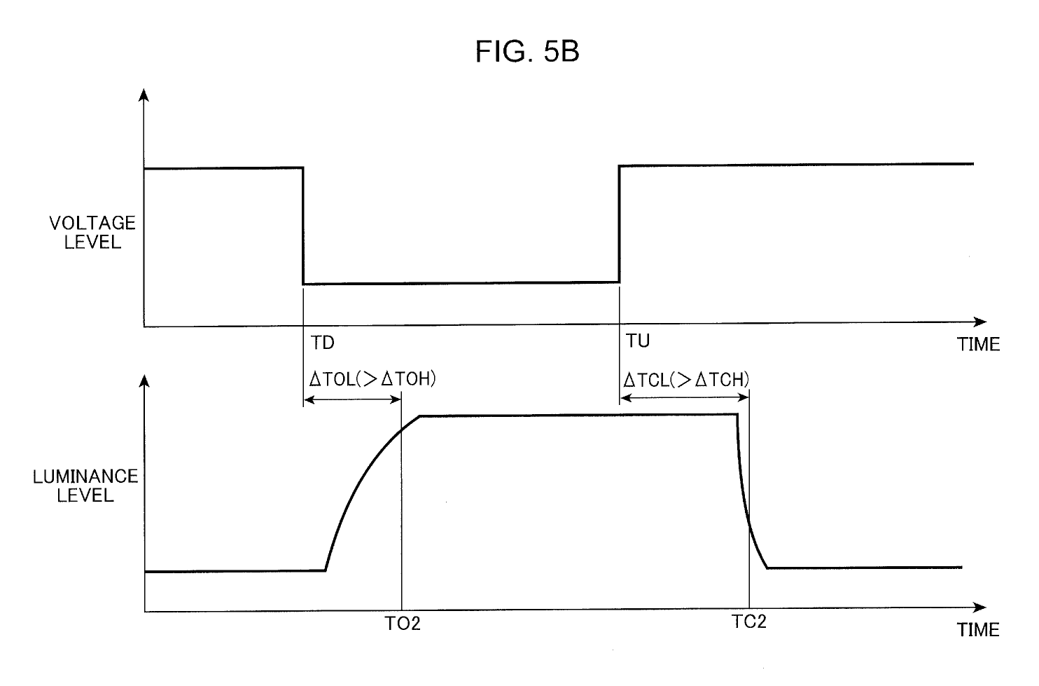

FIGS. 5A and 5B are schematic graphs showing the characteristic data measured by the measurement system 900. The characteristic data are described with reference to FIGS. 4 to 5B.

FIG. 5A is a graph of the characteristic data obtained under a high voltage applied from the power supply 930 to the drive circuit 113. The upper graph shows a variance in the voltage output from the power supply 930. The lower graph shows a variance in the luminance output from the luminance indicator 920.

The power supply 930 drops the voltage at the time TD and raises the voltage at the time TU. The left or right shutter 111, 112 opens in response to the voltage drop at the time TD. Subsequently, the luminance obtained through the left or right shutter 111, 112 reaches 90% of the maximum luminance at the time TO1. The left or right shutter 111, 112 closes in response to the voltage rise at the time TU. Subsequently, the luminance obtained through the left or right shutter 111, 112 becomes 10% of the maximum luminance at the time TC1. FIG. 5A shows a differential value “ΔTOH” between the times TO1 and TD and a differential value “ΔTCH” between TC1 and TU.

FIG. 5B is a graph showing the characteristic data under a low voltage applied from the power supply 930 to the drive circuit 113. The upper graph shows a variance in the voltage output by the power supply 930. The lower graph shows a variance in the luminance output from the luminance indicator 920.

The power supply 930 drops the voltage at the time TD and raises the voltage at the time TU. The left or right shutter 111, 112 opens in response to the voltage drop at the time TD. Subsequently, the luminance obtained through the left or right shutter 111, 112 reaches 90% of the maximum luminance at the time TO2. The left or right shutter 111, 112 closes in response to the voltage rise at the time TU. Subsequently, the luminance obtained through the left or right shutter 111, 112 becomes 10% of the maximum luminance at the time TC2. FIG. 5B shows a differential value “ΔTOL” between TO2 and TD and a differential value “ΔTCL” between the times TC2 and TU. In the present embodiment, the differential value “ΔTOL” is greater than the differential value “ΔTOH” described with reference to FIG. 5A. The differential value “ΔTCL” is greater than the differential value “ΔTCH” described with reference to FIG. 5A.

The memory 142 may store data about the aforementioned differential values in association with voltage levels applied to the drive circuit 113. Accordingly, the data stored in the memory 142 may represent a response delay of the left and right shutters 111, 112 in correspondence with a fluctuation in the voltage levels. It is described hereinafter how to control the left and right shutters 111, 112 by means of the characteristic data.

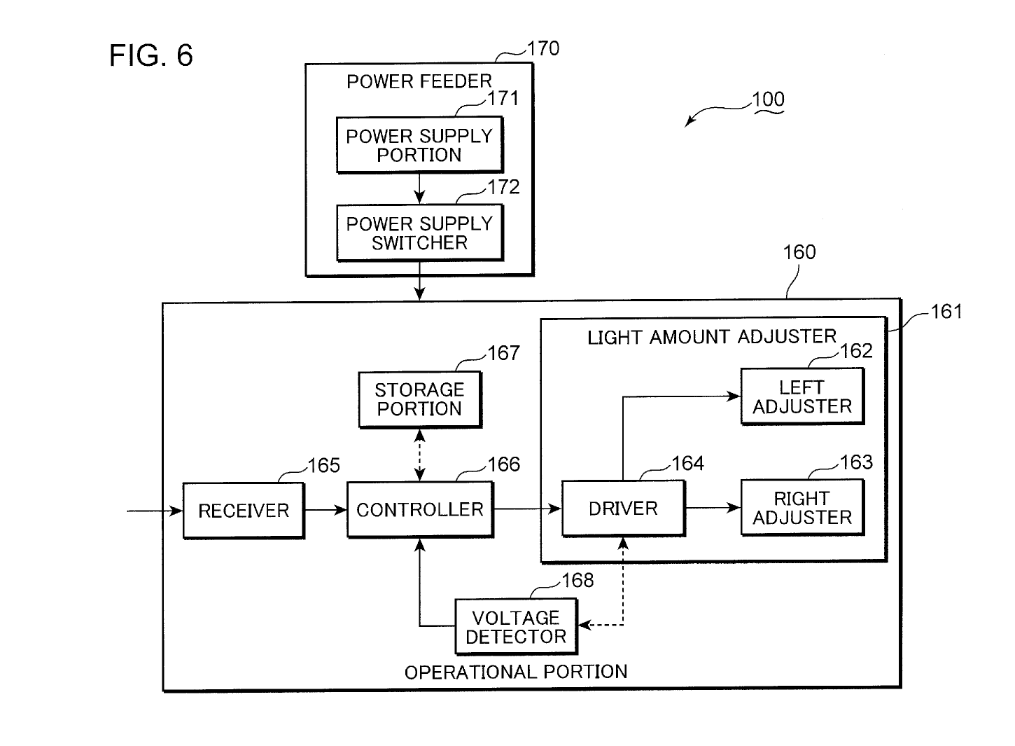

FIG. 6 is a schematic block diagram showing a functional configuration of the eyewear device 100. The eyewear device 100 is described with reference to FIGS. 3 and 6.

The eyewear device 100 includes an operational portion 160, which is responsible for the adjustment operation, and a power feeder 170, which feeds power required by the operational portion 160.

The power feeder 170 includes a power supply portion 171, which stores the power, and a power supply switcher 172, which controls power supply to the operational portion 160. The power supply portion 171 corresponds to the battery 144 described with reference to FIG. 3. The power supply switcher 172 corresponds to the switch device 130 described with reference to FIG. 3. The power amount stored in the power supply 171 decreases because of the adjustment operation, signal receptions and signal processing operations, which are performed by the operational portion 160.

The operational portion 160 includes a light amount adjuster 161 configured to execute the adjustment operation. The light amount adjuster 161 includes a left adjuster 162, which adjusts a light transmission amount to the left eye, a right adjuster 163, which adjusts a light transmission amount to the right eye, and a driver 164, which drives the left and right adjusters 162, 163.

While the display device displays a left frame image, the driver 164 drives the left adjuster 162 to increase a transmission amount of image light to the left eye. Meanwhile, the driver 164 causes the right adjuster 163 to keep a decreased light transmission amount to the right eye. After causing the left adjuster 162 to keep the increased light transmission amount to the left eye for a predetermined period, the driver 164 operates the left adjuster 162 to decrease the transmission amount of image light to the left eye.

While the display device displays a right frame image, the driver 164 drives the right adjuster 163 to increase a transmission amount of image light to the right eye. Meanwhile, the driver 164 causes the left adjuster 162 to keep a decreased light transmission amount to the left eye. After causing the right adjuster 163 to keep the increased light transmission amount to the right eye for a predetermined period, the driver 164 operates the right adjuster 163 to decrease the transmission amount of the image light to the right eye.

In the present embodiment, the light amount adjuster 161 corresponds to the shutter portion 110. The left adjuster 162 corresponds to the left shutter 111. The right adjuster 163 corresponds to the right shutter 112. The driver 164 corresponds to the drive circuit 113.

The increase in a light transmission amount to the left eye by means of the left adjuster 162 means that the left shutter 111 is opened. The decrease in a light transmission amount to the left eye by means of the left adjuster 162 means that the left shutter 111 is closed. The increase in a light transmission amount to the right eye by means of the right adjuster 163 means that the right shutter 112 is opened. The decrease in a light transmission amount to the right eye by means of the right adjuster 163 means that the right shutter 112 is closed.

The eyewear device 100 further includes a receiver 165 configured to receive synchronous control signals from the display device. The receiver 165 corresponds to the receiving device 150 described with reference to FIG. 3.

The eyewear device 100 further includes a controller 166 configured to control the driver 164 of the light amount adjuster 161. The receiver 165 outputs synchronous control signals to the controller 166. For instance, the controller 166 may carry out averaging processes on reception times, at which the synchronous control signals are received, to determine a timing of increasing periods defined by the synchronous control signals (a timing of a period in which a light transmission amount to the left eye is increased by the left adjuster 162 and/or a timing of a period in which a light transmission amount to the right eye is increased by the right adjuster 163) or a timing of decreasing periods (a timing of a period in which a light transmission amount to the left eye is decreased by the left adjuster 162 and/or a timing of a period in which a light transmission amount to the right eye is decreased by the right adjuster 163). The controller 166 may compare the aforementioned characteristic data with a voltage applied to the driver 164, and correct the determined timing of the increasing or decreasing period. The controller 166 then controls the driver 164 in response to the corrected timing of the increasing or decreasing period. Consequently, the adjustment operation of the left and right adjusters 162, 163 driven by the driver 164 may be controlled appropriately. The controller 166 corresponds to the CPU 140 and the clock 141 described with reference to FIG. 3. In the present embodiment, the controller 166 is exemplified as the first controller.

The eyewear device 100 includes a storage portion 167, which stores the characteristic data representing a relationship between a voltage level applied to the driver 164 and an operation speed of the light amount adjuster 161, and a voltage detector 168, which detects a voltage level applied to the driver 164. In the present embodiment, the voltage level applied to the driver 164 depends on the power amount stored in the power supply portion 171. Therefore, the voltage level of the driver 164 detected by the voltage detector 168 represents the power amount stored in the power supply portion 171. The storage portion 167 corresponds to the memory 142 described with reference to FIG. 3. The voltage detector 168 corresponds to the voltage detecting device 143 described with reference to FIG. 3. In the present embodiment, the voltage detector 168 is exemplified as the power detector.

The controller 166 refers to the storage portion 167 and acquires the characteristic data representing a relationship between a voltage level applied to the driver 164 and an operation speed of the light amount adjuster 161. In addition, data about an applied voltage to the driver 164 may be output from the voltage detector 168 to the controller 166. The controller 166 compares the characteristic data with the output data obtained from the voltage detector 168 and corrects fluctuation timings defined by synchronous control signals. The correction processes performed by the controller 166 is described hereinafter.

### (Display Device)

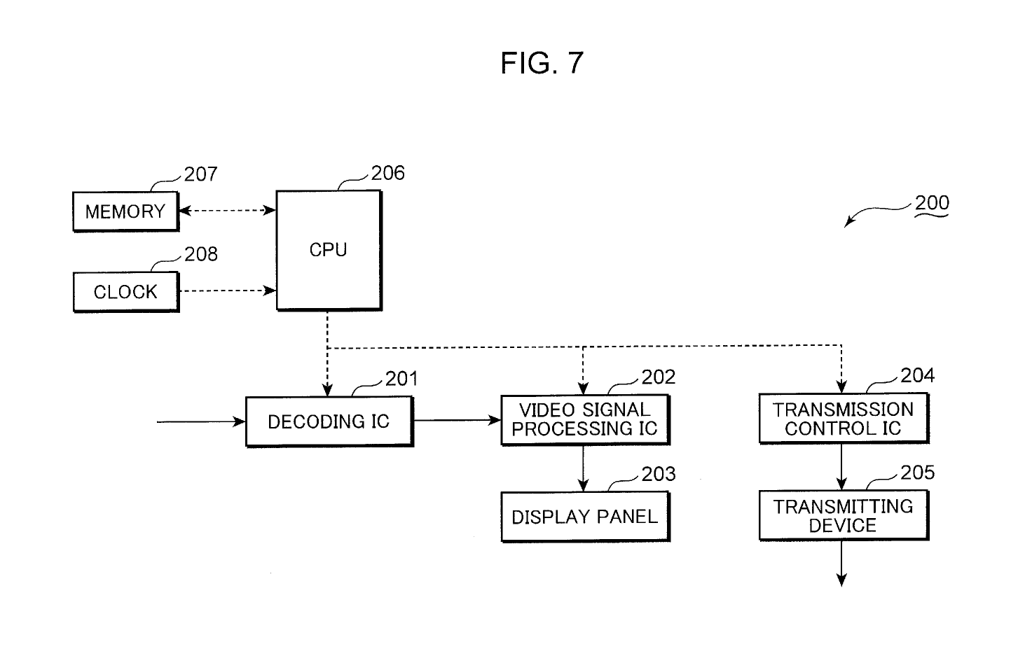

FIG. 7 is a schematic block diagram showing a hardware configuration of the display device 200. The display device 200 is described with reference to FIGS. 3 and 7.

The display device 200 has a decoding IC 201 to which video signals are input. The video signals are coded before the input to the decoding IC 201. The decoding IC 201 decodes the video signals and outputs resultant video data in a predetermined format. The video signal may be coded according to a scheme such as MPEG (Motion Picture Experts Group)-2, MPEG-4 or H264.

The display device 200 further includes a video signal processing IC 202. The decoding IC 201 outputs the decoded video signals to the video signal processing IC 202. The video signal processing IC 202 processes the decoded video signals to create video data for displaying a stereoscopic video. For example, the video signal processing IC 202 may extract video data corresponding to the left frame image and video data corresponding to the right frame image from the video signals. The video signal processing IC 202 may then output the video data corresponding to the left frame image and the video data corresponding to the right frame image, alternately. Otherwise, the video data corresponding to the left frame image and the video data corresponding to the right frame image may be automatically generated from the video signals, which are output from the decoding IC 201 to the video signal processing IC 202. The video signal processing IC 202 may output the video data corresponding to the left frame image and the video data corresponding to the right frame image, alternately.

The display device 200 further includes a display panel 203 configured to display left and right frame images alternately. The video signal processing IC 202 outputs the video data corresponding to the left and right frame images in accordance with a signal input scheme corresponding to the display panel 203.

The video signal processing IC 202 may perform other processes (e.g., color adjustment processes, frame rate adjustment processes, etc.) in accordance with characteristics of the display panel 203. If the video signal processing IC 202 interpolates a video between frames of the video data generated by the decoding IC 201, a frame rate of the video displayed on the display panel 203 increases.

The display device 200 further includes a transmission control IC 204 configured to generate synchronous control signals, which are transmitted to the receiving device 150 of the eyewear device 100. The synchronous control signals generated by the transmission control IC 204 are used for notifying the display start and/or end of frame images displayed on the display panel 203. As described above, the eyewear device 100 uses the display start and/or end times of frame images, which are notified by synchronous control signals, as a reference of a timing of a period in which the left or right shutter 111, 112 increases or decreases a light transmission amount to the left or right eye (a timing of the increasing or decreasing period). The eyewear device 100 corrects the reference timing defined by the synchronous control signals to operate the left and right shutters 111, 112 at a timing in accordance with characteristics of the shutter portion 110.

The display device 200 further includes a transmitting device 205 configured to transmit synchronous control signals. In the present embodiment, the transmitting device 205 may be a light emitter configured to emit infrared light. The transmitting device 205 may be a radio element capable of transmitting radio signals. The transmission control IC 204 controls the transmitting device 205. The transmitting device 205 transmits synchronous control signals under control of the transmission control IC 204. The synchronous control signals are transmitted in synchronization with display of left and right frame images.

The display device 200 further includes a CPU 206 configured to control the decoding IC 201, the video signal processing IC 202 and the transmission control IC 204. The CPU 206 is responsible for controlling the video signal processing IC 202 and the transmission control IC 204. Therefore, the CPU 206 may appropriately synchronize transmission of synchronous control signals with display of left and right frame images.

The display device 200 further includes a memory 207 configured to store programs executed by the CPU 206. The memory 207 may be used as a region for storing resultant data from the execution of the programs by the CPU 206. A volatile RAM (Random Access Memory) or non-volatile ROM (Read Only Memory) may be used as the memory 207.

The display device 200 further includes a clock 208 configured to supply clock signals to the CPU 206. The CPU 206 may use the clock signals to appropriately synchronize transmission of synchronous control signals with display of left and right frame images.

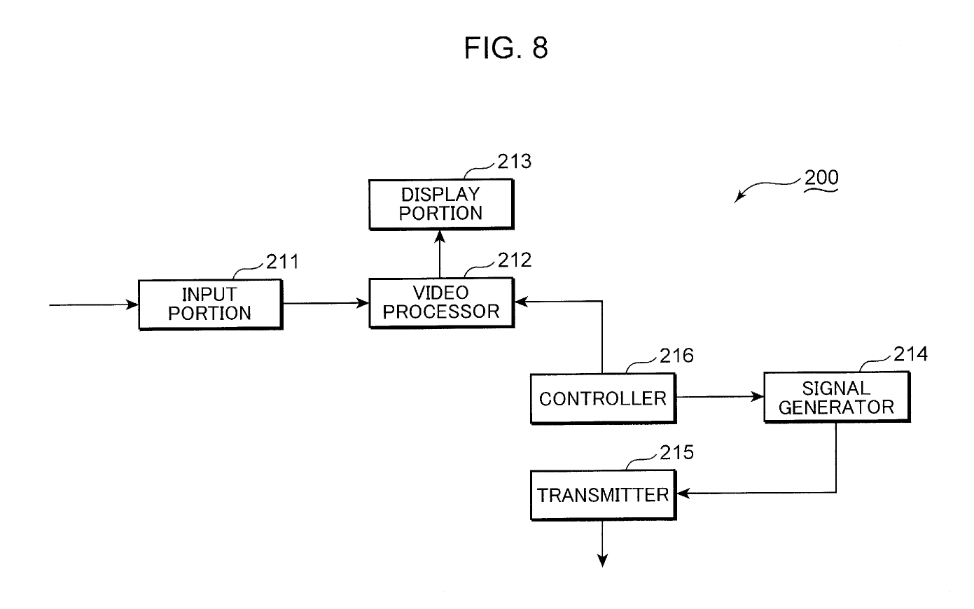

FIG. 8 is a schematic block diagram showing a functional configuration of the display device 200. The display device 200 is further described with reference to FIGS. 6 to 8.

The display device 200 includes an input portion 211, to which video signals are input. The video signals are coded before the input to the input portion 211. The input portion 211 decodes the video signals to output resultant video data in a predetermined format. The video signals may be coded according to a scheme such as MPEG (Motion Picture Experts Group)-2, MPEG-4, or H264. The input portion 211 corresponds to the decoding IC 201 described with reference to FIG. 7.

The display device 200 further includes a video processor 212. The input portion 211 outputs decoded video signals to the video processor 212. The video processor 212 generates video data in response to the video signals, in order to display left and right frame images. The video processor 212 corresponds to the video signal processing IC 202 described with reference to FIG. 7.

The display device 200 further includes a display portion 213. Video data for displaying a left frame image and video data for displaying a right frame image are output alternately from the video processor 212 to the display portion 213. The display portion 213 uses the video date received from the video processor 212 to display the left and right frame images alternately.

The display device 200 further includes a controller 216 configured to control the video processor 212. The video processor 212 processes the aforementioned video signals under control of the controller 216. The controller 216 corresponds to the CPU 206, the memory 207 and the clock 208, which are described with reference to FIG. 7.

The display device 200 further includes a signal generator 214 configured to generate synchronous control signals under control of the controller 216. In synchronization with output of data about a left frame image from the video processor 212 to the display portion 213, the controller 216 causes the signal generator 214 to output a synchronous control signal for notifying the left frame image display. In synchronization with output of data about a right frame image from the video processor 212 to the display portion 213, the controller 216 causes the signal generator 214 to output a synchronous control signal for notifying the right frame image display. The signal generator 214 corresponds to the transmission control IC 204 described with reference to FIG. 7.

The display device 200 further includes a transmitter 215 configured to transmit synchronous control signals. The signal generator 214 outputs synchronous control signals to the transmitter 215. The transmitter 215 transmits the synchronous control signals to the receiver 165 of the eyewear device 100. The transmitter 215 corresponds to the transmitting device 205 described with reference to FIG. 7.

### (Correction Process)

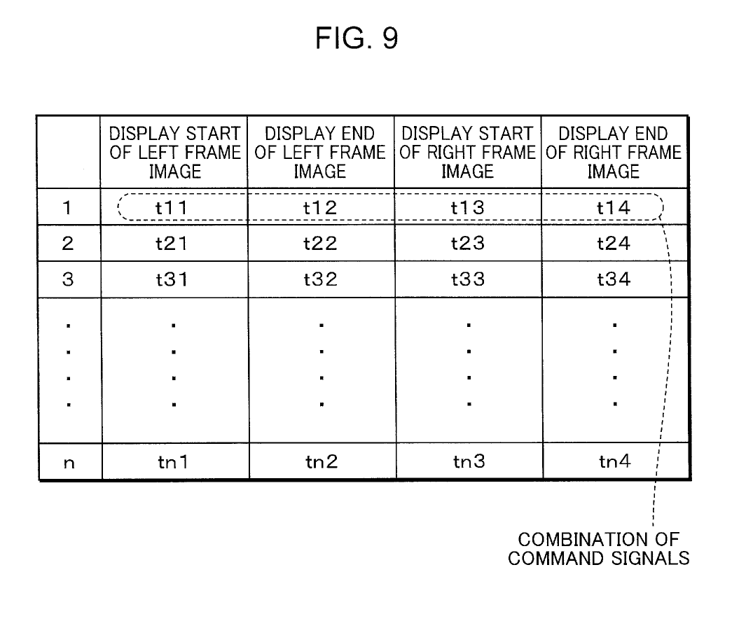

FIG. 9 is a schematic table showing processes for synchronous control signals by the controller 166 of the eyewear device 100. The processes for synchronous control signals are described with reference to FIGS. 6, 8 and 9.

Synchronous control signals generated by the signal generator 214 of the display device 200 may include a command signal for notifying the display start of a left frame image, a command signal for notifying the display end of the left frame image, a command signal for notifying the display start of a right frame image, and a command signal for notifying the display end of the right frame image. These command signals are different in waveform from each other. With reference to waveforms of the command signals, the controller 166 of the eyewear device 100 may understand notification contents provided by the command signals.

For example, the controller 166 of the eyewear device 100 sequentially stores data about a time period from reception of the aforementioned command signals to when a light transmission amount through the shutter portion 110 becomes 50% of the maximum light transmission amount, in the storage portion 167. FIG. 9 shows time data (“t11” to “tn4”) stored in the storage portion 167.

If a predetermined number of combinations of command signals (referred to as “command signal combination,” hereinafter), which consist of a command signal for notifying the display start of a left frame image, a command signal for notifying the display end of the left frame image, a command signal for notifying the display start of a right frame image, and a command signal for notifying the display end of the right frame image, are stored in the storage portion 167, the controller 166 generates reference data defined by the synchronous control signals.

A differential value may be calculated between a reception time, at which a command signal indicating the display end of a left frame image is received and the display start time of the left frame image, in the command signal combination. A differential value may be calculated between a reception time, at which a command signal indicating the display start of a right frame image is received, and the display start of the left frame image, in the command signal combination. A differential value may be calculated between a reception time, at which a command signal indicating the display end of the right frame image is received, and the display start of the left frame image, in the command signal combination. If the differential values obtained from these calculations are averaged, by using the command signal for notifying the display start of the left frame image as a reference, averaged reception times of the other command signals are obtained.

A differential value between times of the command signal reception for notifying the display start of the left frame image may be calculated between the preceding command signal combination and the subsequent command signal combination. If these differential values are averaged, an averaged reception cycle of the command signal combination may be calculated.

With the aforementioned calculations about the differential values, the controller 166 may generate reference data defined by the synchronous control signals. If a signal received by the receiver 165 significantly deviates from the reference data, the controller 166 may process the signal received by the receiver 165 as a noise signal.

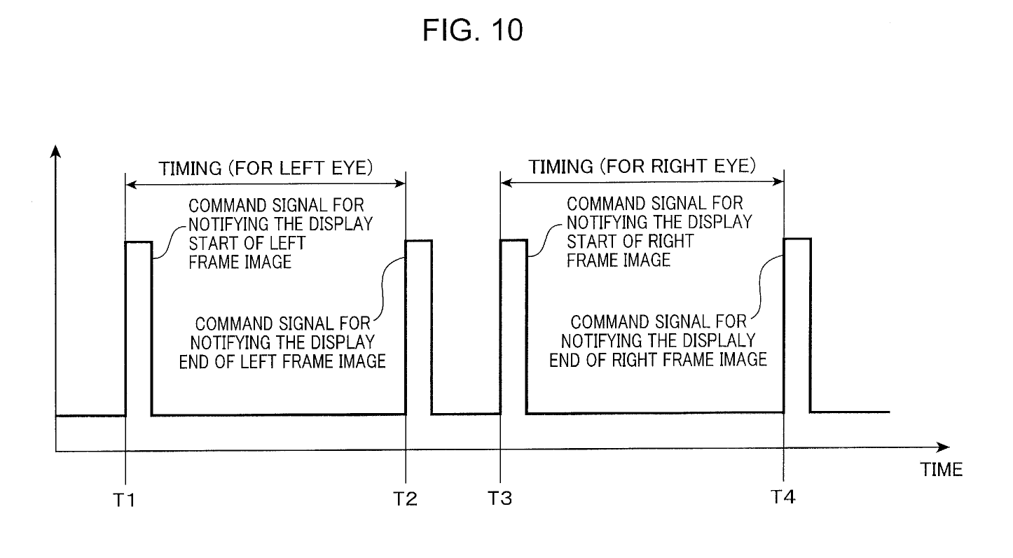

FIG. 10 is a schematic graph showing the reference data obtained by the aforementioned calculations. The reference data are described with reference to FIGS. 6, 8 and 10.

As a result of the aforementioned processes performed by the controller 166 of the eyewear device 100, the controller 166 determines that the display of the left frame image is started at the time T1 and ended at the time T2. The controller 166 then determines that the display of the right frame image is started at the time T3 and ended at the time T4. A period between the times T1 and T2 is illustrated as the timing defined by the synchronous control signal (for the left eye). A period between the times T3 and T4 is illustrated as the timing defined by the synchronous control signal (for the right eye).

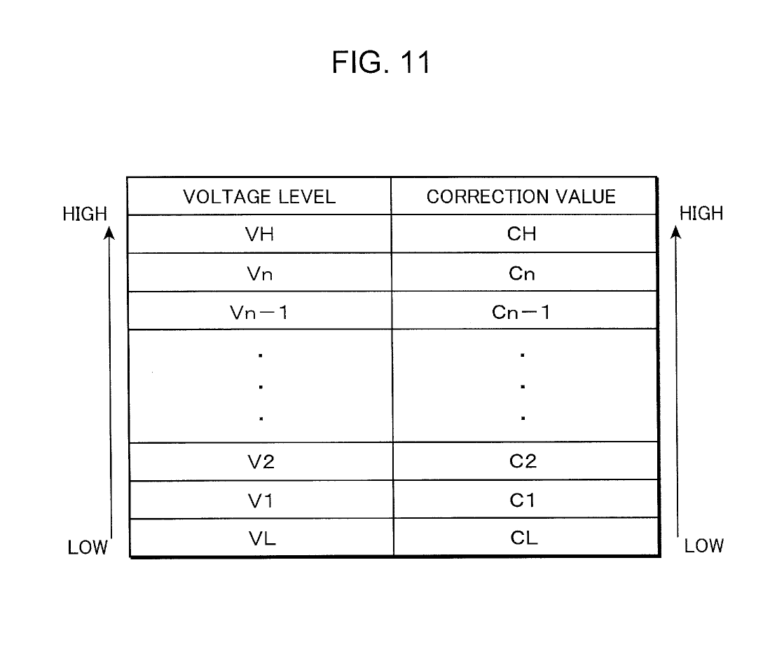

FIG. 11 is a schematic table showing the characteristic data stored in the storage portion 167 of the eyewear device 100. Correction processes performed on the reference data are described with reference to FIGS. 5A to 6 and FIG. 11.

Voltage levels applied to the driver 164 and correction values associated with the voltage level are stored in the storage portion 167 as the characteristic data resulting from the measurement described with reference to FIGS. 5A and 5B. In FIG. 11, the voltage level under the maximum power amount stored in the power supply portion 171 is expressed as “VH”. In FIG. 11, the voltage level under the minimum power amount stored in the power supply portion 171 (the lowest power amount at which the light amount adjuster 161 can execute the adjustment operation) is expressed as “VL”.

The storage portion 167 stores the correction value CH in association with the voltage level VH. The storage portion 167 also stores the correction value CL in association with the voltage level VL. The storage portion 167 also stores several correction values (Cn to C1) in association with voltage levels between VH and VL. In the present embodiment, the correction values stored in the storage portion 167 gradually increase from the correction value CL toward the correction value CH, like the voltage levels.

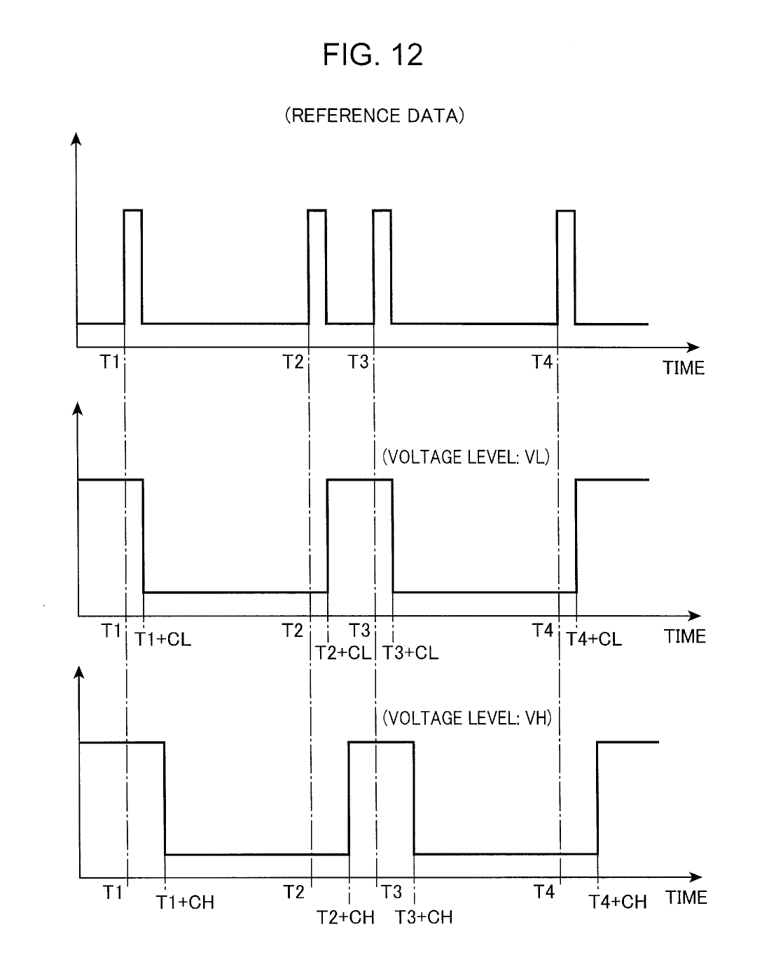

FIG. 12 is a graph schematically showing the correction processes performed by the controller 166 of the eyewear device 100. The correction processes performed by the controller 166 are described with reference to FIGS. 5A to 6 and FIGS. 10 to 12.

The upper graph of FIG. 12 shows the reference data described with reference to FIG. 10. The middle graph of FIG. 12 shows a fluctuation in voltage level of the drive signal, which is output under control of the controller 166 from the driver 164 to the left and right adjusters 162, 163, under the voltage level VL detected by the voltage detector 168. The lower graph of FIG. 12 shows a fluctuation in voltage level of the drive signal, which is output under control of the controller 166 from the driver 164 to the left and right adjusters 162, 163, under the voltage level VH detected by the voltage detector 168.

The controller 166 compares the voltage level at the driver 164, which is detected by the voltage detector 168, with the characteristic data stored in the storage portion 167. If data output from the voltage detector 168 to the controller 166 indicate that the voltage level “VL” is detected, the controller 166 chooses and uses the correction value CL, which is associated with the voltage level VL in the characteristic data stored in the storage portion 167, to correct the reference data. If data output from the voltage detector 168 to the controller 166 indicate that the voltage level “VH” is detected, the controller 166 chooses and uses the correction value CH, which is associated with the voltage level VH in the characteristic data stored in the storage portion, to correct the reference data.

After it is determined that the correction value CL is used to correct the reference data, the controller 166 adds the correction value CL to each of the times T1, T2, T3 and T4. After it is determined that the correction value CH is used to correct the reference data, the controller 166 adds the correction value CH to each of the times T1, T2, T3 and T4. The driver 164 changes the voltage under control of the controller 166 at the times after the addition of the correction value CL or CH to operate the left and right adjusters 162, 163. Since the correction value CL is smaller than the correction value CH as described with reference to FIG. 11, the voltage level of the drive signal obtained under the voltage level “VL” detected by the voltage detector 168 fluctuates earlier than under the voltage level “VH” detected by the voltage detector 168. Therefore, the left and right adjusters 162, 163 are activated earlier when the voltage detector 168 detects the voltage level “VL” than when the voltage detector 168 detects the voltage level “VH”.

On the other hand, as described with reference to FIGS. 5A and 5B, the left and right adjusters 162, 163 are operated more slowly when the voltage detector 168 detects the voltage level “VL” than when the voltage detector 168 detects the voltage level “VH.” Thus, the resultant difference in activation time of the left and right adjusters 162, 163 from the difference between the correction values CL and CH is substantially offset by operational characteristics of the left and right adjusters 162, 163. Consequently, the light transmission amount to the left and right eyes reaches the target value a substantially constant period after the times T1, T2, T3 and T4 of the reference data. Thus, the fluctuation in the power amount stored in the power supply portion 171 may become less influential to the operation timings of the left and right adjusters 162, 163.

In the present embodiment, the correction values associated with the voltage levels are all the same between the timing at which the light amount adjuster 161 increases a light amount and the timing at which the light amount adjuster 161 decreases a light amount. Alternatively, different correction values may be used between the timing at which the light amount adjuster 161 increases a light amount and the timing at which the light amount adjuster 161 decreases a light amount. Otherwise, the correction values may be applied to one of the timing at which the light amount adjuster 161 increases a light amount and the timing at which the light amount adjuster 161 decreases a light amount.

As described with reference to FIGS. 5A and 5B, the characteristic data are acquired for the left and right adjusters 162, 163 individually. Consequently, the correction control may be implemented in response to inherent characteristics of the eyewear device 100. In other words, not only differences in performance between eyewear devices of different models but also differences in performance between eyewear devices of the same model may be reduced. The correction processes may be executed by means of other calculation processes. Correction values may be defined by calculations used in the correction processes. Therefore, the principles of the present embodiment are not at all limited to the aforementioned calculation processes and settings of correction values.

### (Video System)

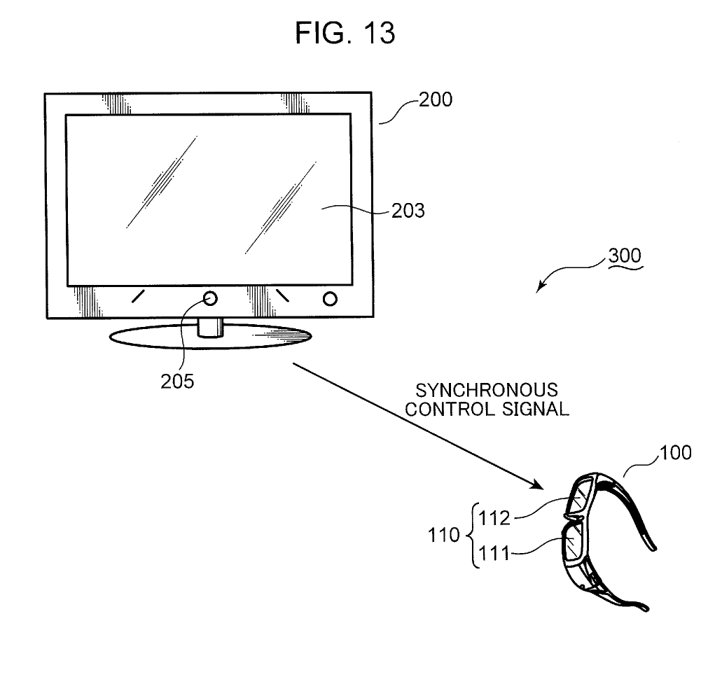

FIG. 13 is a schematic view of the video system 300. The video system 300 is described with reference to FIG. 13.

The video system 300 includes the eyewear device 100 and the display device 200. The display device 200 uses the display panel 203 to display a left frame image observed by the left eye and a right frame image observed by the right eye, alternately. The display device 200 transmits synchronous control signals defining fluctuation timings, at which a transmission amount of image light to the left and right eyes increase or decrease, from the transmitting device 205 to the eyewear device 100. In response to the synchronous control signals, the eyewear device 100 operates the left and right shutters 111, 112. Through the aforementioned correction control, the shutter portion 110 may adjust the fluctuation timings appropriately. Therefore, the eyewear device 100 may appropriately adjust the transmission amount of image light entering the left and right eyes, and allow an observer to stereoscopically perceive the video displayed on the display panel 203.

In the present embodiment, the fluctuation timings are adjusted entirely by the eyewear device 100. This simplifies communication between the display device 200 and the eyewear device 100.

### (Control Method of Eyewear Device)

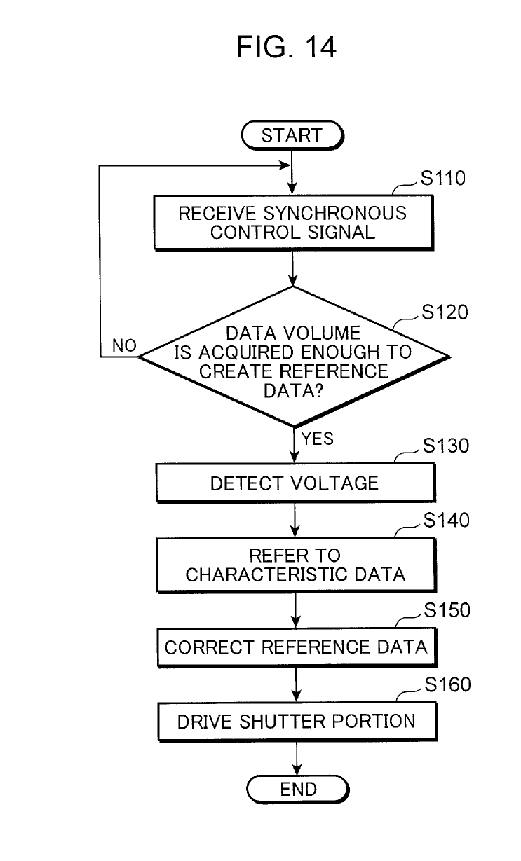

FIG. 14 is a schematic flowchart showing a control method of the eyewear device 100. The control method of the eyewear device 100 is described with reference to FIG. 14.

### (Step S110)

In step S110, the receiver 165 receives synchronous control signals. Reception times of the synchronous control signals and information notified by the synchronous control signals are stored in the storage portion 167 via the controller 166. Step S120 is then executed.

### (Step S120)

In step S120, the controller 166 determines whether or not the storage portion 167 stores data enough to generate reference data. If a data volume stored in the storage portion 167 is insufficient, step S110 is executed again. Therefore, the receiver 165 continues to receive synchronous control signals until the data enough to generate the reference data are stored in the storage portion 167.

Once a data volume stored in the storage portion 167 becomes sufficient to generate the reference data, the controller 166 generates the reference data. The reference data represent the fluctuation timings defined by the synchronous control signals, as described above. After the reference data are generated, step S130 is executed.

### (Step S130)

In step S130, the voltage detector 168 detects a voltage applied to the driver 164. Data about the detected voltage are output from the voltage detector 168 to the controller 166. Step S140 is executed after the output of the voltage data.

### (Step S140)

In step S140, the controller 166 compares the characteristic data stored in the storage portion 167 with the voltage data output from the voltage detector 168 to determine a correction value. Step S150 is executed after the correction values are determined.

### (Step S150)

In step S150, the controller 166 uses the determined correction value to correct the reference data and generate correction data. Step S160 is executed after the correction data are generated.

### (Step S160)

In step S160, the controller 166 uses the correction data to control the driver 164. Accordingly, the driver 164 may drive the left and right adjusters 162, 163 at the timings adjusted appropriately in response to the characteristic data and the voltage level applied to the driver 164. Consequently, the left and right adjusters 162, 163 may increase or decrease a light transmission amount to the left or right eye at the appropriately adjusted fluctuation timings.

### Second Embodiment

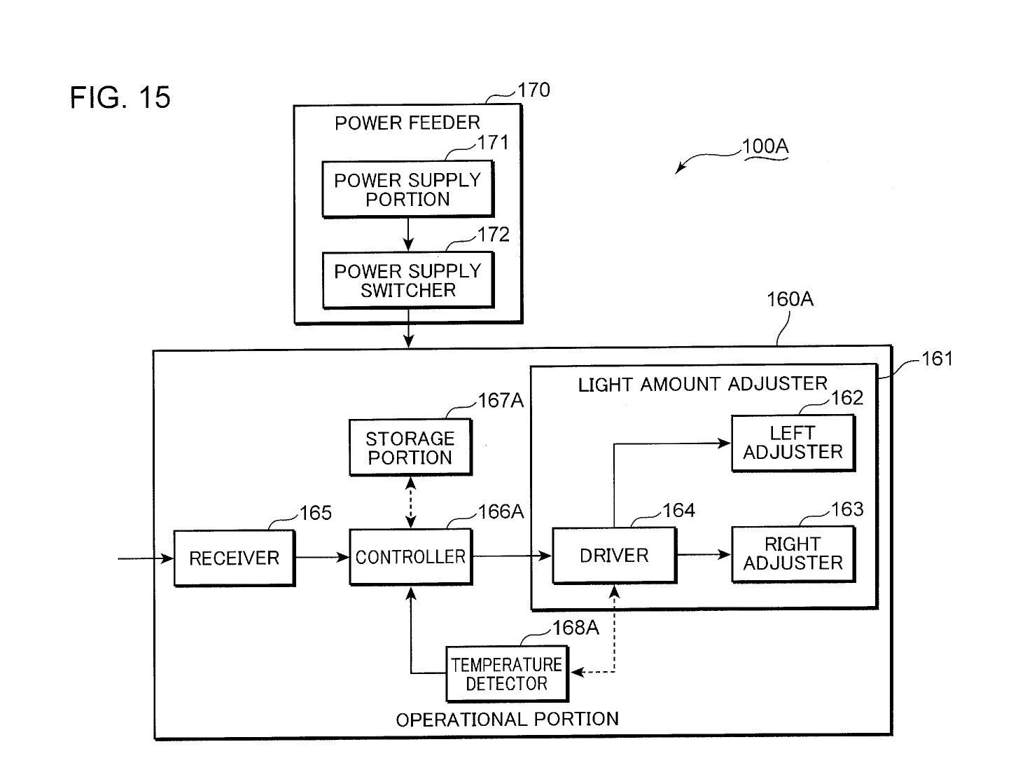

FIG. 15 is a schematic block diagram showing a functional configuration of the eyewear device 100A according to the second embodiment. The same reference numerals are applied to the same elements as those of the first embodiment. The description in the first embodiment is recited to describe the elements denoted by the same reference numerals. Differences between the first and second embodiments are described below.

The eyewear device 100A includes an operational portion 160A in addition to the power feeder 170 described in the context of the first embodiment. The operational portion 160A includes a controller 166A, a storage portion 167A and a temperature detector 168A in addition to the receiver 165 and the light amount adjuster 161, which are described in the context of the first embodiment.

If the left and right adjusters 162, 163 are formed with liquid crystal, a response speed (operation speed) of the left and right adjusters 162, 163 often depends on an environmental temperature under which a video is observed. Particularly, the response speed of the left and right adjusters 162, 163 are susceptible to an ambient temperature. Accordingly, in the present embodiment, the temperature detector 168A detects a temperature of the driver 164 as the environmental temperature. A general thermal sensor may be suitably used as the temperature detector 168A.

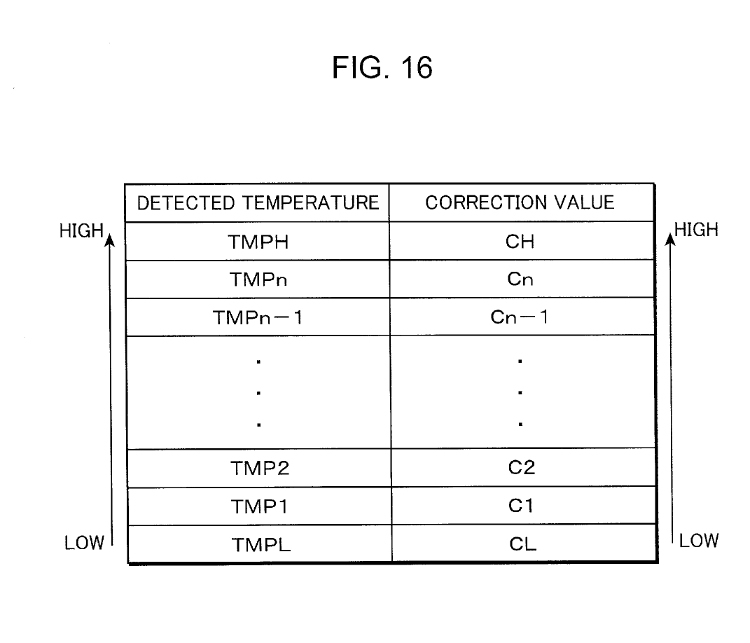

FIG. 16 is a table schematically showing characteristic data stored in the storage portion 167A. The eyewear device 100A is further described with reference to FIGS. 15 and 16.

The storage portion 167A stores temperature data about the maximum temperature TMPH and the minimum temperature TMPL, which are expected for the temperature detector 168A to detect, and several temperatures between the maximum and minimum temperatures TMPH, TMPL, as well as data about correction values associated with the temperature data. In the present embodiment, the correction value CH associated with the maximum temperature TMPH is the largest value whereas the correction value CH associated with the minimum temperature TMPL is the smallest value. The correction values are set to gradually become small as the detected temperature decreases.

The correction values are defined in response to a relationship between a temperature of the driver 164 (i.e., the environmental temperature under which the video is observed) and the operation speed of the left and right adjusters 162, 163. It is preferred that operational characteristics of the eyewear device 100A are verified under various thermal environments to determine the correction values. Accordingly, the inherent characteristic data about the eyewear device 100A are stored in the storage portion 167A.

The controller 166A compares the characteristic data stored in the storage portion 167A with the temperature data output from the temperature detector 168A, to determine the correction value corresponding to the temperature of the driver 164.

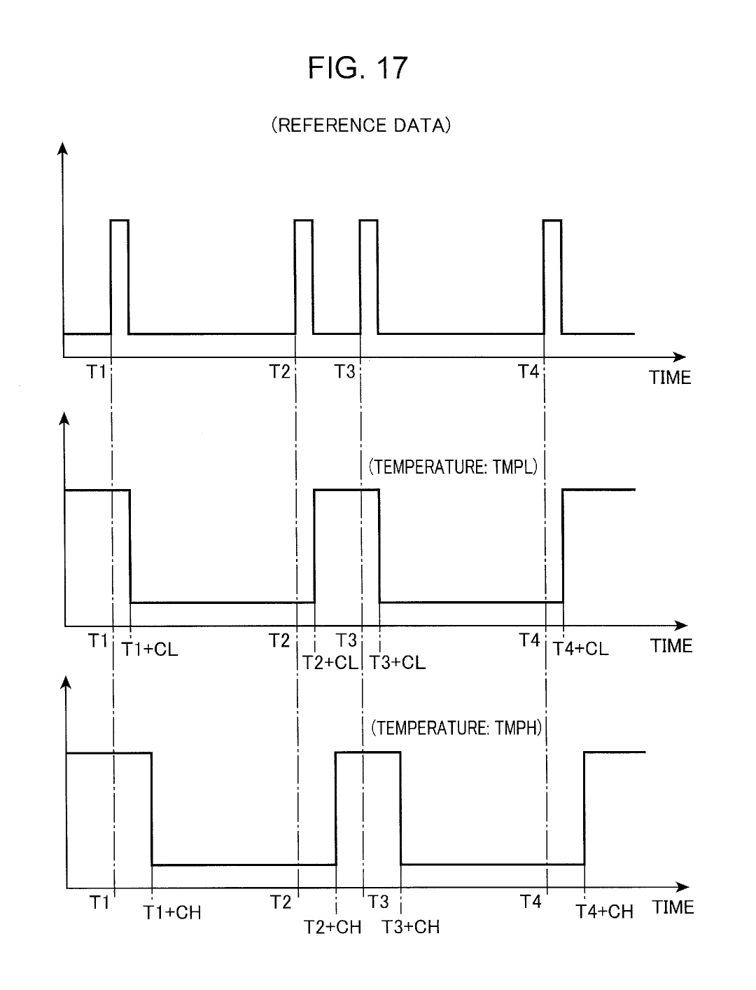

FIG. 17 is a graph schematically showing correction processes performed by the controller 166A. The correction processes performed by the controller 166A is described with reference to FIGS. 15 to 17.

The upper graph of FIG. 17 shows the reference data. With the method described in the context of the first embodiment, the controller 166A uses synchronous control signals received by the receiver 165 to generate the reference data.

The middle graph of FIG. 17 shows a fluctuation in voltage level of a drive signal, which is output from the driver 164 to the left and right adjusters 162, 163 under control of the controller 166A when the temperature detector 168A detects the minimum temperature TMPL. The lower graph of FIG. 17 shows a fluctuation in voltage level of the drive signal, which is output from the driver 164 to the left and right adjusters 162, 163 under control of the controller 166A when the temperature detector 168A detects the maximum temperature TMPH.

The controller 166A compares the temperature of the driver 164 detected by the temperature detector 168A with the characteristic data stored in the storage portion 167A. If the data output from the temperature detector 168A to the controller 166A indicates that the temperature “TMPL” is detected, the controller 166A chooses and uses the correction value VL, which is associated with the temperature TMPL in the characteristic data stored in the storage portion 167A, to correct the reference data. If the data output from the temperature detector 168A to the controller 166A indicates that the temperature “TMPH” is detected, the controller 166A chooses and uses the correction value CH, which is associated with the temperature TMPH in the characteristic data stored in the storage portion 167A, to correct the reference data.

After it is determined that the correction value CL is used to correct the reference data, the controller 166A adds the correction value CL to each of the times T1, T2, T3 and T4. After it is determined that the correction value CH is used to correct the reference data, the controller 166A adds the correction value CH to each of the times T1, T2, T3 and T4. The driver 164 then changes the voltage under control of the controller 166A at the times after the addition of the correction values CL, CH to operate the left and right adjusters 162, 163. Consequently, a timing of a period in which a light transmission amount to the left or right eye increases (the timing of the increasing period) or a timing of a period in which a light transmission amount to the left or right eye decreases (the timing of the decreasing period) is adjusted by the correction amount associated with the temperature. In the present embodiment, the controller 166A is exemplified as the first controller.

Since the correction value CL is smaller than the correction value CH as described with reference to FIG. 16, the voltage level of the drive signal under the temperature “TMPL” detected by the voltage detector 168A fluctuates earlier than under the temperature “TMPH” detected by the voltage detector 168A. Therefore, the left and right adjusters 162, 163 are activated earlier when the voltage detector 168A detects the temperature “TMPL” than when the voltage detector 168A detects the temperature “TMPH.”

When the left and right adjusters 162, 163 are formed with liquid crystal, in general, operation of the left and right adjusters 162, 163 tends to slow down as the environmental temperature decreases. Thus, a resultant difference in activation time of the left and right adjusters 162, 163 from the difference between the correction values CL and CH is substantially offset by operational characteristics of the left and right adjusters 162, 163. Consequently, a light transmission amount to the left or right eye reaches the target value a substantially constant period after the times T1, T2, T3 and T4 of the reference data. Thus, the thermal fluctuation in the light amount adjuster 161 becomes less influential to the operation timing of the left and right adjusters 162, 163. The correction processes may be executed by means of other calculation processes. The correction values may be defined in accordance with calculations used in the correction process. Therefore, the principles of the present embodiment are not at all limited to the aforementioned calculation processes and settings of the correction values.

In the present embodiment, the correction values defined in response to the environmental temperature are all the same between the timing, at which the light amount adjuster 161 increases a light amount, and the timing, at which the light amount adjuster 161 decreases a light amount. Alternatively, different correction values may be used between the timing, at which the light amount adjuster 161 increases a light amount, and the timing, at which the light amount adjuster 161 decreases a light amount. Otherwise, the correction values may be applied to one of the timing, at which the light amount adjuster 161 increases a light amount, or the timing, at which the light amount adjuster 161 decreases a light amount.

Correction to the fluctuation timings may be executed in response to the voltage detection described in the context of the first embodiment and the temperature detection described in the context of the second embodiment.

### Third Embodiment

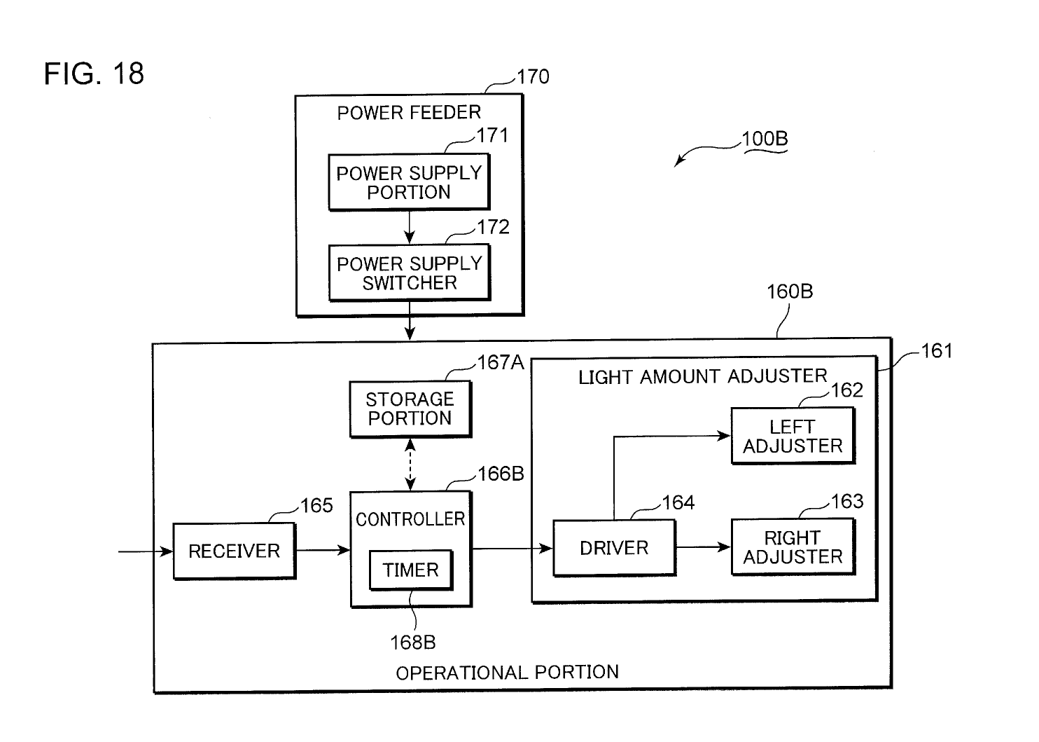

FIG. 18 is a schematic block diagram showing a functional configuration of the eyewear device 100B according to the third embodiment. The same reference numerals are applied to the same elements as those of the second embodiment. The description provided in the second embodiment is recited to describe the elements denoted by the same reference numerals. Differences between the second and third embodiments are described below.

The eyewear device 100B includes an operational portion 160B in addition to the power feeder 170 described in the context of the second embodiment. The operational portion 160B includes a controller 166B in addition to the receiver 165, the light amount adjuster 161 and the storage portion 167A, which are described in the context of the second embodiment. The controller 166B includes a timer 168B which measures a time period after the power feeder 170 starts supplying power to the operational portion 160B (referred to as “power supply period,” hereinafter). The clock 141 described with reference to FIG. 3 may be used as the timer 168B.

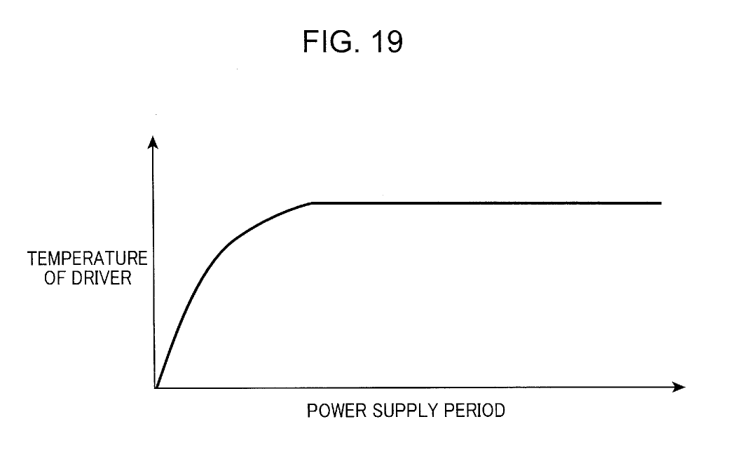

FIG. 19 is a schematic graph showing a relationship between the power supply period and the temperature of the driver 164. The eyewear device 100B is further described with reference to FIGS. 16, 18 and 19.

The temperature of the driver 164 increases gradually as a result of the power supply from the power feeder 170 to the operational portion 160B. The relationship between the power supply period and the temperature rise of the driver 164 is verified individually for the eyewear device 100B. The controller 166B may estimate a temperature of the driver 164 on the basis of the power supply period measured by the timer 168B and a correlation between the power supply period and the temperature rise shown in FIG. 19.

The characteristic data described with reference to FIG. 16 are stored in the storage portion 167A. The controller 166B compares the estimated temperature with the characteristic data to determine the correction amount. The controller 166B then adjusts the fluctuation timings according to the method described in the context of the second embodiment. In the present embodiment, the controller 166B is exemplified as the first controller. The timer 168B is exemplified as the temperature detector.

The eyewear device 100B of the present embodiment does not have any detecting element configured to directly detect a temperature of the driver 164. The timer 168B may be programs for acquiring information about the power supply period by means of the clock signals. Therefore, a physical structure of the eyewear device 100B is simpler than that described in the second embodiment.

### Fourth Embodiment

### Display Device

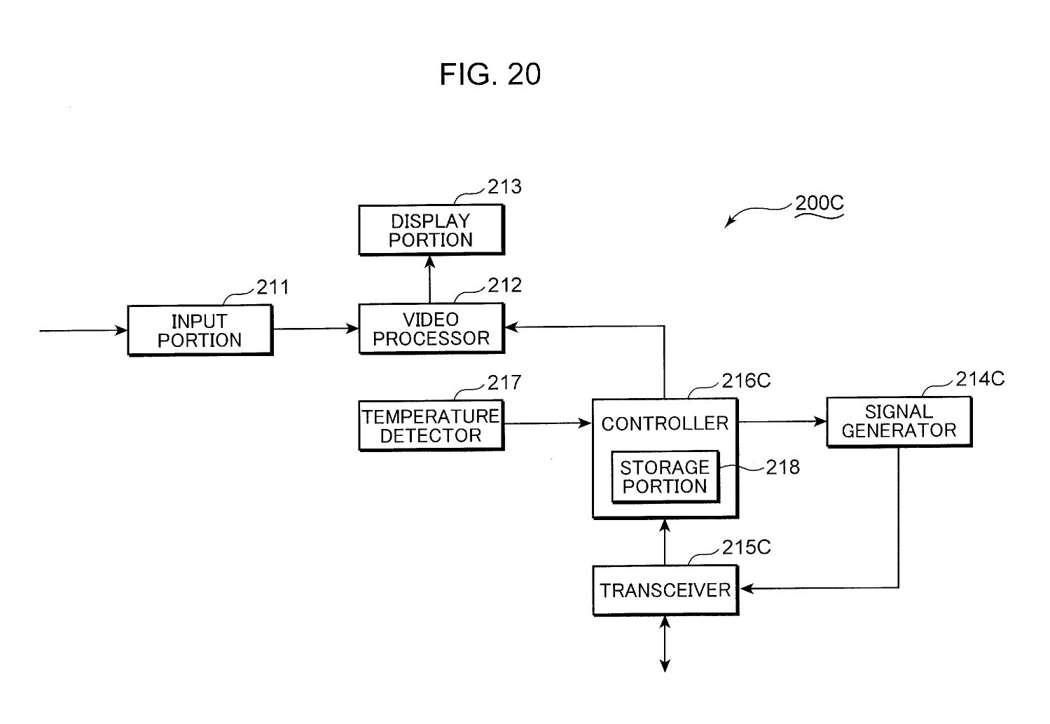

FIG. 20 is a schematic block diagram showing a functional configuration of the display device 200C according to the fourth embodiment. The same reference numerals are applied to the same elements as those of the first embodiment. The description provided in the first embodiment is recited to describe the elements denoted by the same reference numerals. Differences between the first and fourth embodiments are described below.

The display device 200C includes the input portion 211, the video processor 212 and the display portion 213, which are described in the context of the first embodiment. Video signals are input to the input portion 211. In response to the video signals received through the input portion 211, data about a left frame image observed by the left eye and data about a right frame image observed by the right eye are output from the video processor 212 to the display portion 213 alternately. The display portion 213 displays the left and right frame images alternately in response to the output from the video processor 212. Consequently, an observer may stereoscopically perceive the video displayed on the display portion 213.

The display device 200C further includes a controller 216C configured to control the video processor 212. The controller 216C determines display timings of the left and right frame images. The display portion 213 displays the left and right frame images sequentially at the determined display timings. In the present embodiment, the controller 216C is exemplified as the second controller.

The display device 200C further includes a signal generator 214C configured to generate synchronous control signals under control of the controller 216C to notify the display timings of the left and right frame images. Unlike the first embodiment, the information about the display timings notified by the synchronous control signals from the signal generator 214C is corrected on the basis of the display timings determined by the controller 216C for the video processor 212. The correction to the display timings is described later.

The display device 200C further includes a transceiver 215C configured to transmit synchronous control signals. In the present embodiment, it is preferred that the signal generator 214C generates radio signals as the synchronous control signals. The transceiver 215C transmits the radio signals generated as the synchronous control signals. In the present embodiment, the signal generator 214C and the transceiver 215C are exemplified as the control signal transceiver. The transmitting device 205 described with reference to FIG. 7 may be used as the transceiver 215C.

The display device 200C further includes a temperature detector 217 configured to detect an environmental temperature under which a video is observed. Data about the temperature detected by the temperature detector 217 are output to the controller 216C. The controller 216C uses the temperature data to correct the display timings. A general thermal sensor may be suitably used as the temperature detector 217.

### (Video System)

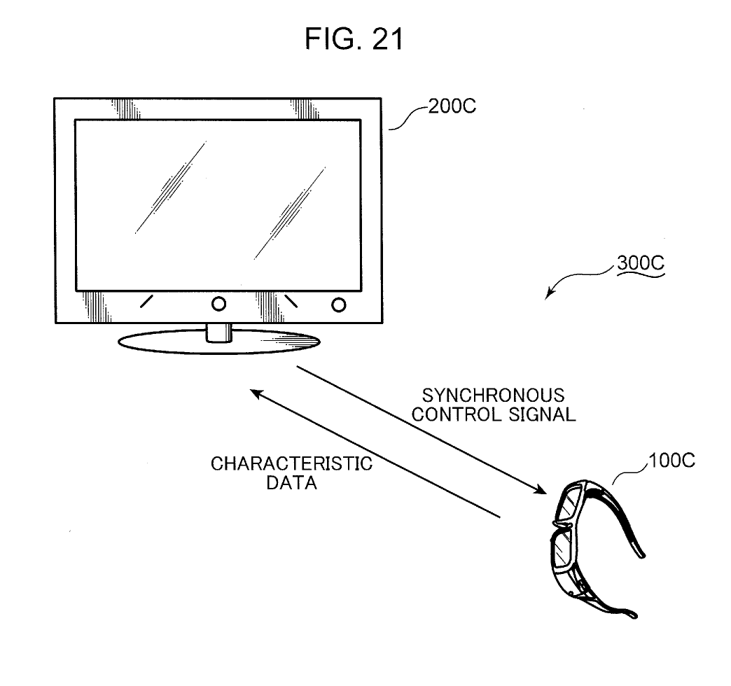

FIG. 21 is a schematic view of the video system 300C. The video system 300C is described with reference to FIGS. 20 and 21.

The video system 300C includes the display device 200C and an eyewear device 100C. The transceiver 215C transmits synchronous control signals to the eyewear device 100C. In response to the synchronous control signals, the eyewear device 100C performs the adjustment operation so that fluctuation timings, at which a transmission amount of image light to the left and right eyes increases or decreases, are synchronized with the left and right frame images displayed on the display portion 213. Unlike the first embodiment, the information about the display timings, which are contained in synchronous control signals transmitted from the display device 200C, are corrected. Thus, there may be few calculation processes performed by the eyewear device 100C to correct the information.

Characteristic data about the adjustment operation executed by the eyewear device 100C is transmitted from the eyewear device 100C to the display device 200C. The transceiver 215C of the display device 200C receives the characteristic data. The characteristic data are described hereinafter.

The transceiver 215C outputs the received characteristic data to the controller 216C. The controller 216C includes a storage portion 218 configured to store the characteristic data output from the transceiver 215C. Accordingly, the controller 216C may keep holding the characteristic data. The memory 207 described in the context of FIG. 7 may be used as the storage portion 218.

The controller 216C uses the characteristic data and the temperature data output from the temperature detector 217 to correct the display timings, which are determined for the video processor 212. The controller 216C uses the corrected display timings to control the signal generator 214C. Synchronous control signals generated by the signal generator 214C consequently contain the information about the corrected display timings.

In the present embodiment, packet communication according to a communication scheme such as Bluetooth™, ZigBee or WiFi is executed between the display device 200C and the eyewear device 100C. It should be noted that the communication system between the display device 200C and the eyewear device 100C should not be interpreted as limitations for the principles of the present embodiment in any way.

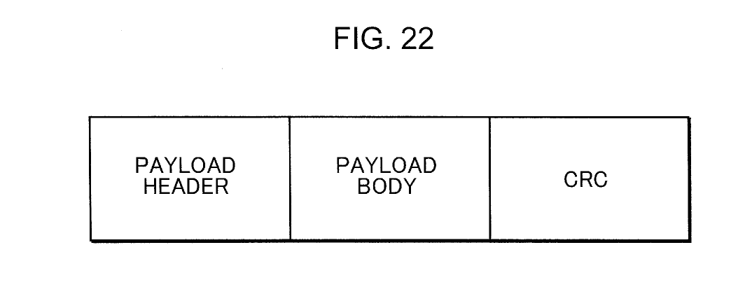

FIG. 22 is a schematic view showing a packet structure used in the communication between the display device 200C and the eyewear device 100C. The packet structure shown in FIG. 22 is based on Bluetooth™. The packet structure should not be interpreted as limitations for the principles of the present embodiment in any way. The communication between the display device 200C and the eyewear device 100C is described with reference to FIGS. 20 to 22.

The packet structure contains a payload header, a payload body and a CRC. Timing information about the corrected display timings are contained in the payload body of synchronous control signals transmitted from the display device 200C to the eyewear device 100C. The characteristic data transmitted from the eyewear device 100C to the display device 200C are also contained in the payload body.

The controller 216C of the display device 200C may control the signal generator 214C to change the timing information stored in the payload body, in response to the characteristic data stored in the storage portion 218 or the temperature data output from the temperature detector 217. Alternatively, the controller 216C may control the signal generator 214C and the transceiver 215C to change transmission timings, at which synchronous control signals are transmitted, in response to the characteristic data stored in the storage portion 218 or the temperature data output from the temperature detector 217.

### (Eyewear Device)

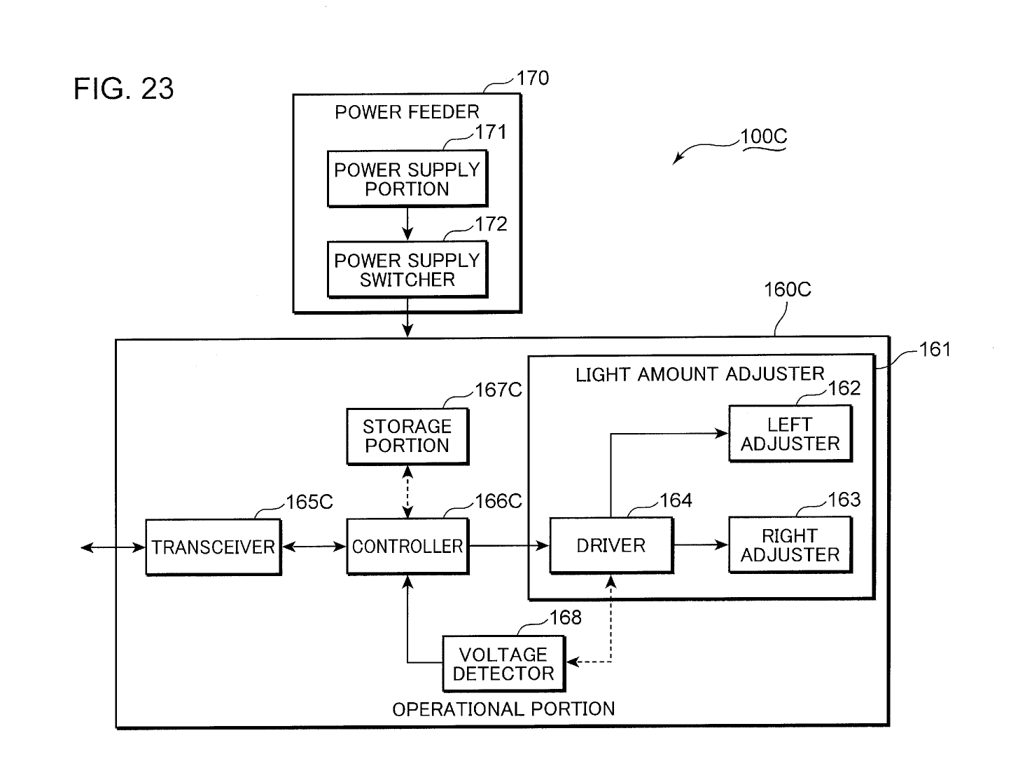

FIG. 23 is a schematic block diagram showing a functional configuration of the eyewear device 100C. The eyewear device 100C is described with reference to FIGS. 20 and 23.

The eyewear device 100C includes an operational portion 160C in addition to the power feeder 170 described in the context of the first embodiment. The operational portion 160C includes the light amount adjuster 161 and the voltage detector 168, which are described in the context of the first embodiment. The light amount adjuster 161 uses the left and right adjusters 162, 163 to execute the adjustment operation for adjusting a transmission amount of image light to the left and right eyes. The power feeder 170 includes the power supply portion 171, which stores power used for the adjustment operation performed by the light amount adjuster 161, and the power supply switcher 172, which controls power supply from the power supply portion 171. The voltage detector 168 detects a voltage applied to the driver 164 which drives the left and right adjusters 162, 163. As described in the context of the first embodiment, the voltage applied to the driver 164 represents a power amount stored in the power supply portion 171. Therefore, the detection of a voltage by means of the voltage detector 168 means detection of a power amount stored in the power supply portion 171.

The eyewear device 100C further includes a storage portion 167C configured to store the characteristic data. Data about the voltage detected by the voltage detector 168 and data about the temperature detected by the temperature detector 217 described with reference to FIG. 20 are used for the correction processes performed by the controller 216C of the display device 200C. The storage portion 167C stores the characteristic data which represent a relationship between an environmental temperature and the adjustment operation performed by the light amount adjuster 161 and another relationship between a voltage applied to the driver 164 and the adjustment operation performed by the light amount adjuster 161.

The eyewear device 100C further includes a controller 166C configured to control the driver 164 in response to synchronous control signals transmitted from the display device 200C. Unlike the first embodiment, information about display timings, which is contained in the synchronous control signals, are corrected by the display device 200C. Thus, the controller 166C of the eyewear device 100C does not have to execute calculations for the correction processes on the synchronous control signals. In the present embodiment, the controller 166C of the eyewear device 100C is exemplified as the first controller.

The eyewear device 100C further includes a transceiver 165C configured to receive synchronous control signals. The transceiver 165C outputs synchronous control signals to the controller 166C. The controller 166C controls the driver 164 in response to the synchronous control signals. Accordingly, the left and right adjusters 162, 163 may appropriately adjust a light transmission amount to the left or right eye.

The controller 166C reads the characteristic data stored in the storage portion 167C. The transceiver 165C then transmits the characteristic data to the display device 200C. The transceiver 215C of the display device 200C receives the characteristic data. The characteristic data are stored in the storage portion 218 provided in the controller 216C of the display device 200C. In the present embodiment, the transceiver 165C of the eyewear device 100C is exemplified as the data transceiver.

### (Characteristic Data)

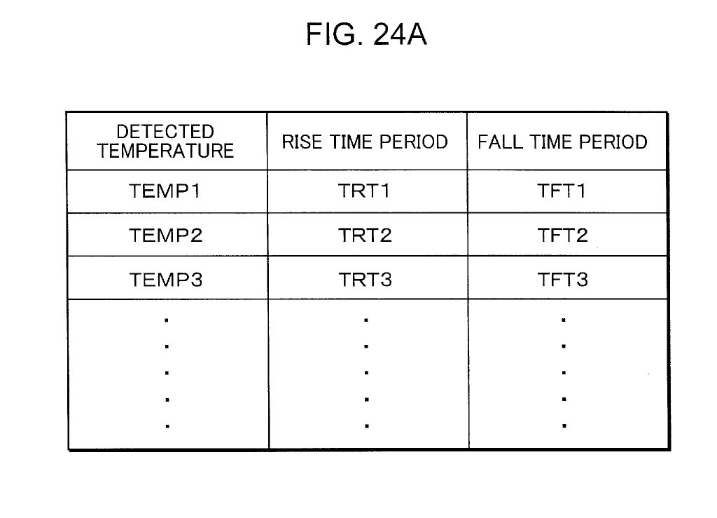

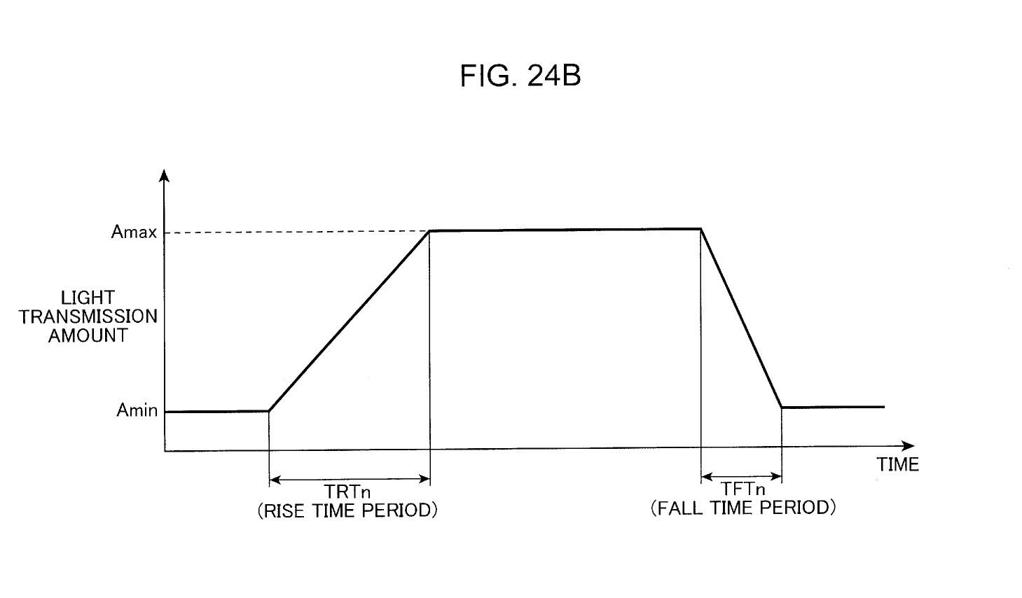

FIG. 24A is a table showing the characteristic data stored in the storage portion 167C of the eyewear device 100C. FIG. 24B is a schematic graph showing an operation speed of the light amount adjuster 161 under a certain detected temperature. The characteristic data are described with reference to FIGS. 20, 23 to 24B.

The graph of FIG. 24B shows a fluctuation in light transmission amount to the left and right eyes at the temperature TEMPn (n is a natural number). In FIG. 24B, the minimum light transmission amount which the left or right adjuster 162, 163 achieves is expressed as “Amin”. In FIG. 24B, the maximum light transmission amount which the left or right adjuster 162, 163 achieves is expressed as “Amax”.

The term “rise time period” shown in the table of FIG. 24A represents a period required for a change from the minimum light transmission amount “Amin” to the maximum light transmission amount “Amax”. The term “fall time period” shown in the table of FIG. 24A represents a period required for a change from the maximum light transmission amount to the minimum light transmission amount “Amin”.

The storage portion 167C stores environmental temperatures (TEMP1, TEMP2, TEMP3, . . . , TEMPn) detected by the temperature detector 217 of the display device 200C in association with the rise time periods (TRT1, TRT2, TRT3, . . . , TRTn) and the fall time periods (TFT1, TFT2, TFT3, . . . , TFTn) corresponding to these temperatures.

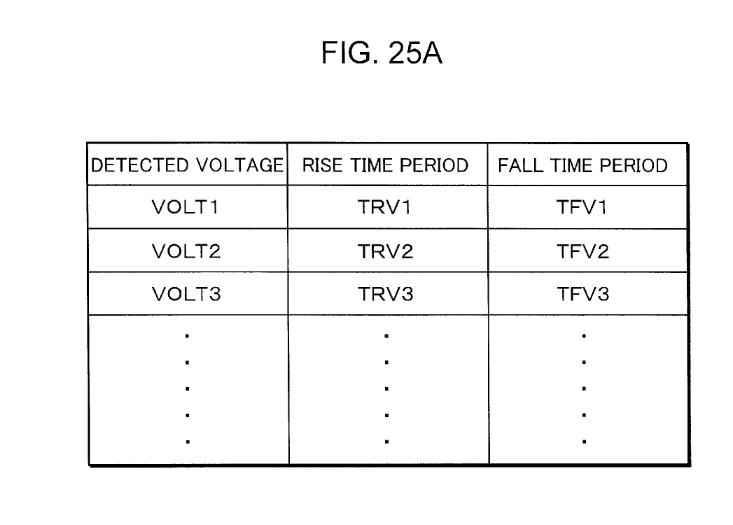

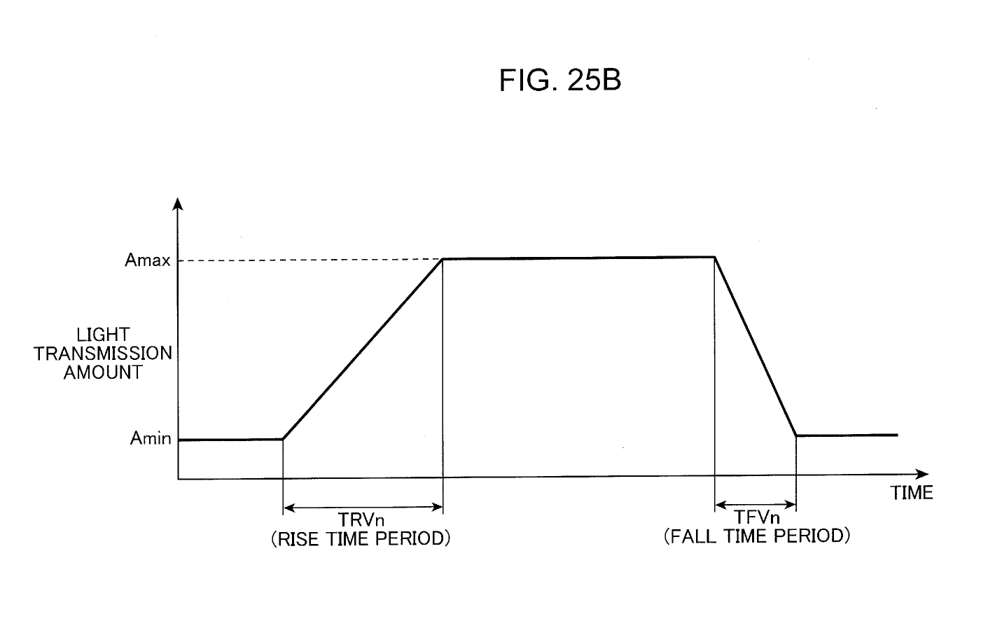

FIG. 25A is a table showing the characteristic data stored in the storage portion 167C of the eyewear device 100C. FIG. 25B is a schematic graph showing an operation speed of the light amount adjuster 161 under a certain detected voltage. The characteristic data are described with reference to FIGS. 20, 23, 25A and 25B.

The graph of FIG. 25B shows a fluctuation in light transmission amount to the left and right eyes at a voltage VOLTn (n is a natural number). In FIG. 25B, the minimum light transmission amount which the left or right adjuster 162, 163 achieves is expressed as “Amin”. In FIG. 25B, the maximum light transmission amount which the left or right adjuster 162, 163 achieves is expressed as “Amax”.

The term “rise time period” shown in the table of FIG. 25A represents a period required for a change from the minimum light transmission amount “Amin” to the maximum light transmission amount “Amax”. The term “fall time period” shown in the table of FIG. 25A represents a period required for a change from the maximum light transmission amount “Amax” to the minimum light transmission amount “Amin”.

The storage portion 167C stores voltages (VOLT1, VOLT2, VOLT3, . . . , VOLTn) detected by the voltage detector 168 of the eyewear device 100C in association with the rise time periods (TRV1, TRV2, TRV3, . . . , TRVn) and the fall time periods (TFV1, TFV2, TFV3, . . . , TFVn) corresponding to these voltages.

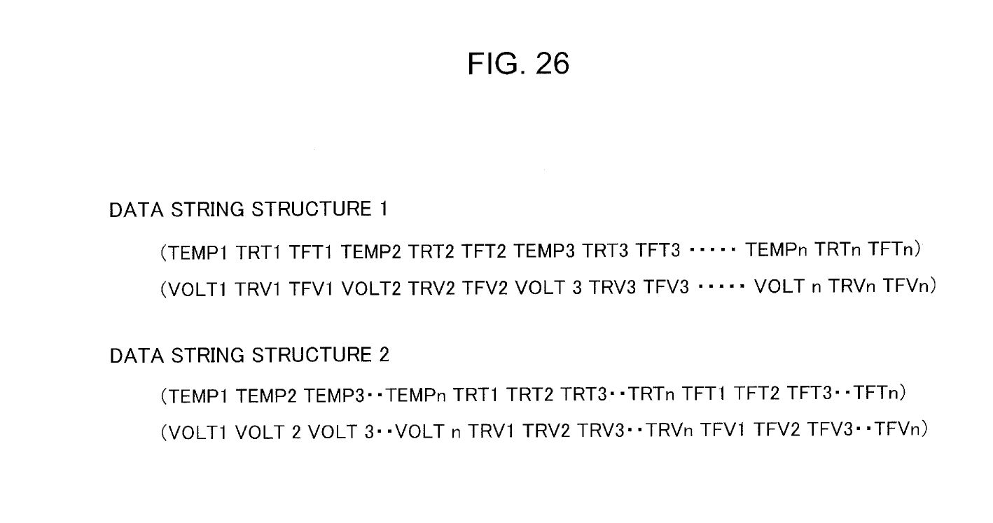

FIG. 26 is a schematic view showing data string structures created by the controller 166C of the eyewear device 100C. The data string structures are described with reference to FIGS. 20, 22, 23, 24A and 25A.

After reading the characteristic data stored in the storage portion 167C, the controller 166C generates packet signals to transmit the characteristic data to the display device 200C. The data in the tables shown in FIGS. 24A and 25A are incorporated in the payload body of the packet structure. The data string structures shown in FIG. 26 schematically shows structures of data strings incorporated in the payload body. It should be noted that the data string structures should not be interpreted as limitation for the principles of the present embodiment in any way.

A data string structure 1 shown in FIG. 26 includes data which are arranged by reading the tables shown in FIGS. 24A and 25A row by row. A data string structure 2 includes data which are arranged by reading the tables shown in FIGS. 24A and 25A column by column. The controller 166C generates a packet signal which contains information expressed by the data string structure shown in FIG. 26. The packet signal generated by the controller 166C is transmitted from the transceiver 165C of the eyewear device 100C to the display device 200C.

The transceiver 215C of the display device 200C receives the packet signal. The controller 216C of the display device 200C interprets the data string structure contained in the packet signal, and stores the characteristic data in the storage portion 218.

It may be preferable that the characteristic data shown in FIG. 24A are created in correspondence to several detected voltages. It may be preferable that the characteristic data shown in FIG. 25A are created in correspondence to several detected temperatures. Consequently, the display device 200C may determine the rise and fall time periods which are associated with a combination of the temperature detected by the temperature detector 217 and the voltage detected by the voltage detector 168.

If the characteristic data shown in FIG. 24A are created in correspondence to several detected voltages and/or if the characteristic data shown in FIG. 25A are created in correspondence to several detected temperatures, the data string structures may occasionally become too long to be contained in a single packet signal. In this case, the transceiver 165C of the eyewear device 100C may divide the data string structure into several packet signals to transmit the characteristic data.

As described above, the voltage detector 168 detects a voltage applied to the driver 164. Data about the detected voltage are output from the voltage detector 168 to the controller 166C. After the packet signal for transmitting the aforementioned characteristic data is generated, the controller 166C generates another packet signal which contains information about the detected voltage. The packet signal which contains the information about the detected voltage is transmitted from the transceiver 165C of the eyewear device 100C to the display device 200C.

The transceiver 215C of the display device 200C receives the packet signal which contains the information about the voltage detected by the voltage detector 168. The transceiver 215C then outputs the information about the detected voltage to the controller 216C.

The temperature detector 217 outputs data about an environmental temperature to the controller 216C, as described above. Therefore, the information about the voltage detected by the voltage detector 168 of the eyewear device 100C and the information about the environmental temperature detected by the temperature detector 217 of the display device 200C are input to the controller 216C.

The controller 216C compares the aforementioned characteristic data with the information about the voltage detected by the voltage detector 168 of the eyewear device 100C and the information about the environmental temperature detected by the temperature detector 217 of the display device 200C, and corrects the display timings determined for the video processor 212.

In the present embodiment, each of the rise and fall time periods is defined as a fluctuation period in which a light transmission amount fluctuates between the maximum light transmission amount and the minimum light transmission amount. The rise and fall time periods may be defined by other ways. For instance, each of the rise and fall time periods may be defined as a fluctuation period in which a light transmission amount fluctuates between 90% of the maximum light transmission amount and 10% of the maximum light transmission amount.

### (Correction of Fluctuation Timings)

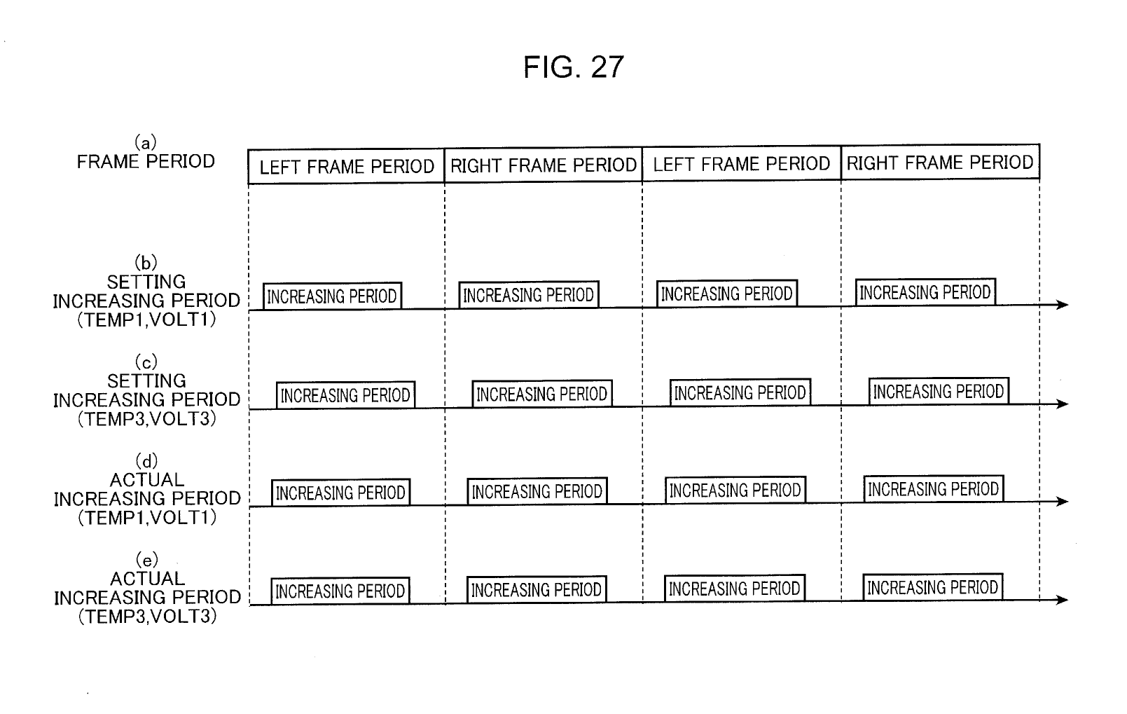

FIG. 27 is a schematic timing chart showing timing correction to a period in which a light transmission amount to the left or right eye is increased. The timing correction to the period, in which a light transmission amount to the left or right eye is increased, is described with reference to FIGS. 20, 23, 24A, 25A and 27.

Section (a) of FIG. 27 shows a left frame period, in which a left frame image is displayed, and a right frame period, in which a right frame image is displayed. The controller 216C controlling the video processor 212 defines the left and right frame periods alternately. The controller 216C controls the video processor 212 so that data about the left frame image are output from the video processor 212 to the display portion 213 during the left frame period. The controller 216C controls the video processor 212 so that data about the right frame image are output from the video processor 212 to the display portion 213 during the right frame period. Consequently, the display portion 213 displays the left frame image in the left frame period and the right frame image in the right frame period.

Each of sections (b) and (c) of FIG. 27 shows timings of the increasing periods set by the controller 216C of the display device 200C (periods in which a light transmission amount to the left or right eye increases). Section (b) of FIG. 27 shows timings of the increasing periods, which are set under “TEMP1” indicated by the temperature data acquired from the temperature detector 217 and “VOLT1” indicated by the voltage data transmitted from the eyewear device 100C. Section (c) of FIG. 27 shows timings of the increasing periods, which are set under “TEMP3” indicated by the temperature data acquired from the temperature detector 217 and “VOLT3” indicated by the voltage data transmitted from the eyewear device 100C.

The rise and fall time periods described with reference to FIGS. 24A and 25A are different between the combination condition of “TEMP1” and “VOLT1” and the combination condition of “TEMP3” and “VOLT3.” Therefore, the controller 216C controls the signal generator 214 to generate synchronous control signals containing different information in the increasing period from each other, in which a light transmission amount is increased, between the aforementioned conditions. In the present embodiment, synchronous control signals generated under the combination condition of “TEMP3” and “VOLT3” contain information to notify a delayed timing of the increasing period, in comparison to synchronous control signals generated under the combination condition of “TEMP1” and “VOLT1”.

Each of sections (d) and (e) of FIG. 27 shows timings of actual increasing periods defined by the adjustment operation of the light amount adjuster 161 of the eyewear device 100C. Section (d) of FIG. 27 shows increasing periods obtained under the settings described with reference to section (b) of FIG. 27. Section (e) of FIG. 27 shows increasing periods obtained under the settings described with reference to section (c) of FIG. 27.

The light amount adjuster 161 may respond to synchronous control signals faster under the combination condition of “TEMP3” and “VOLT3” than under the combination condition of “TEMP1” and “VOLT1.” Thus, differences in the settings described with reference to sections (b) and (c) of FIG. 27 are substantially offset by the fluctuation in operation speed of the light amount adjuster 161. Accordingly, the timings of the increasing periods shown in sections (d) and (e) of FIG. 27 become substantially equivalent to each other. Thus, the eyewear device 100C may stably respond to synchronous control signals under various conditions of an environmental temperature and a stored power amount. In the present embodiment, timings of the increasing periods are adjusted. Alternatively, the decreasing period in which a light transmission amount to the left or right eye decreases may be subjected to the adjustment processes.

### (Control Method of Video System)

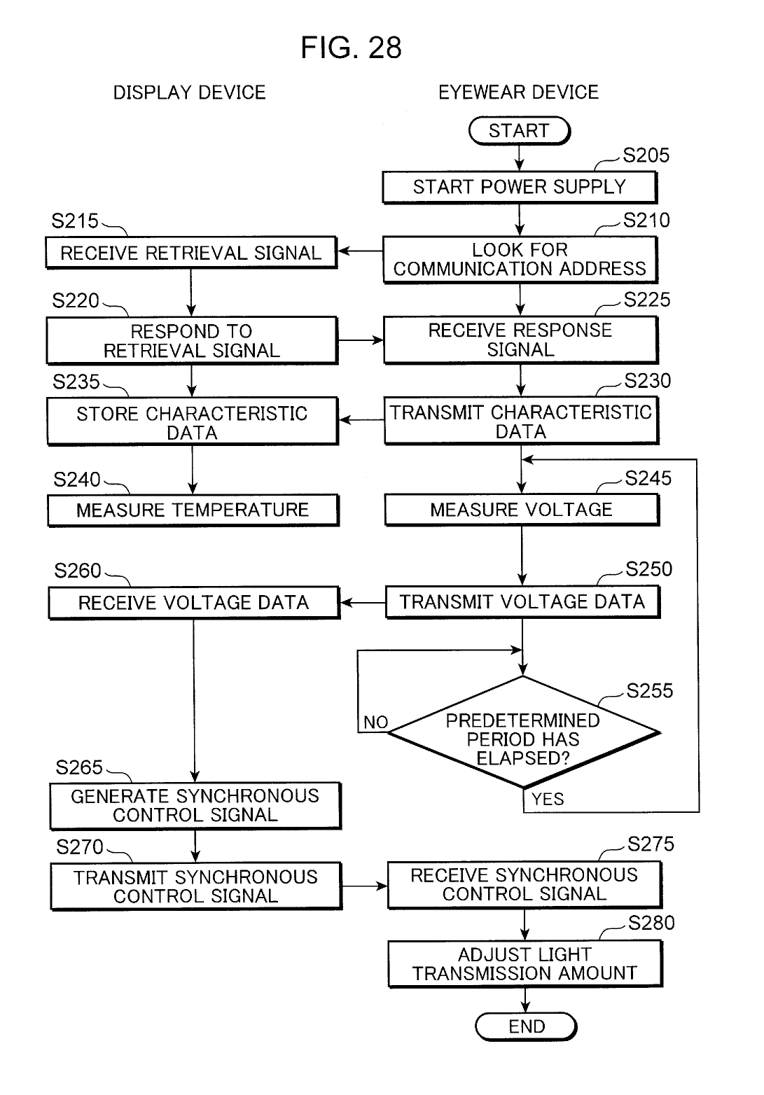

FIG. 28 is a schematic flowchart showing a control method of the video system 300C. The control method of the video system 300C is described with reference to FIGS. 20, 21, 23 and 28.

### (Step S205)

In step S205, the power feeder 170 of the eyewear device 100C starts power supply to the operational portion 160C. Therefore, various elements of the operational portion 160C may be activated. After the power is supplied to the operational portion 160C, step S210 is executed.

### (Step S210)

In step S210, in response to the power supply, the controller 166C of the eyewear device 100C generates retrieval signals to look for the display device 200C capable of communicating with the eyewear device 100C. The retrieval signal may contain information about a communication address of the eyewear device 100C itself. The transceiver 165C of the eyewear device 100C transmits the retrieval signals. After the transmission of the retrieval signals, the display device 200C executes step S215.

### (Step S215)

In step S215, the transceiver 215C of the display device 200C receives the retrieval signals. The transceiver 215C then notifies the controller 216C of the retrieval signal reception together with the information about the communication address of the eyewear device 100C. Subsequently, the display device 200C executes step S220.

### (Step S220)

In step S220, the controller 216C of the display device 200C controls the signal generator 214C to generate response signals for responding to the retrieval signals. The response signal generated by the signal generator 214C contains information about a communication address of the display device 200C itself. The transceiver 215C transmits the response signals to the communication address of the eyewear device 100C. After the transmission of the response signals, the eyewear device 100C executes step S225.

### (Step S225)

In step S225, the transceiver 165C of the eyewear device 100C receives the response signals. The transceiver 165C notifies the controller 166C of the response signal reception together with the information about the communication address of the display device 200C. Consequently, the eyewear device 100C acquires the information about the communication address of the display device 200C while the display device 200C acquires the information about the communication address of the eyewear device 100C. Accordingly, a radio communication channel is opened between the eyewear device 100C and the display device 200C. After the establishment of the radio communication channel, the eyewear device 100C executes step S230.

### (Step S230)

In step S230, the controller 166C of the eyewear device 100C reads the characteristic data stored in advance in the storage portion 167C. The characteristic data have been acquired individually for the eyewear device 100C by means of the measurement technologies described in the context of the first and second embodiments. Therefore, the characteristic data may represent inherent response characteristics of the eyewear device 100C.

The controller 166C uses the read characteristic data to generate packet signals. The transceiver 165C transmits the generated packet signals to the communication address of the display device 200C. After the transmission of the characteristic data, the eyewear device 100C executes step S245. The display device 200C executes step S235.

### (Step S235)

In step S235, the transceiver 215C of the display device 200C receives the packet signals representing the characteristic data. Information about the characteristic data represented by the packet signal is output from the transceiver 215C to the controller 216C. The controller 216C analyzes the information output from the transceiver 215C to reconstruct the characteristic data. The reconstructed characteristic data are stored in the storage portion 218 of the controller 216C. The display device 200C executes step S240 after the characteristic data are stored in the storage portion 218.

### (Step S240)

In step S240, the temperature detector 217 detects an environmental temperature under which a video is observed. The temperature detector 217 outputs data about the detected temperature to the controller 216C.

### (Step S245)

In step S245, the voltage detector 168 detects a voltage applied to the driver 164. The voltage detector 168 outputs data about the detected voltage to the controller 166C. The eyewear device 100C executes step S250 after the output of the voltage data.

### (Step S250)

In step S250, the controller 166C uses the voltage data to generate the packet signals which contain information about the voltage applied to the driver 164. The packet signals are transmitted to the display device 200C through the transceiver 165C. The eyewear device 100C executes step S255 whereas the display device 200C executes step S260, after the transmission of the packet signals.

### (Step S255)

In step S255, the eyewear device 100C measures a time period after the transmission of the packet signals, which is executed in step S250. If the elapsed time period exceeds a predetermined length, step S245 is executed. If the elapsed time period is no longer than the predetermined length, step S255 is continued. Therefore, the packet signals containing the information about the voltage applied to the driver 164 are periodically transmitted to the display device 200C.

### (Step S260)

In step S260, the transceiver 215C of the display device 200C receives the packet signals containing the information about the voltage applied to the driver 164 of the eyewear device 100C. The information about the voltage applied to the driver 164 is then output from the transceiver 215C to the controller 216C. Consequently, the controller 216C acquires the characteristic data, the information about the environmental temperature, and the information about the voltage applied to the driver 164. The display device 200C executes step S265 after the controller 216C acquires the characteristic data, the information about the environmental temperature, and the information about the voltage applied to the driver 164.

### (Step S265)

In step S265, the controller 216C determines timing, at which a light transmission amount to the left or right eye increases or decreases, in response to the display timings defined for the video processor 212 (i.e., the start and/or end timings of frame periods). The controller 216C compares the characteristic data with the information about the environmental temperature and the information about the voltage applied to the driver 164, and corrects the timing determined on the basis of the display timings. The controller 216C causes the signal generator 214C to generate synchronous control signals which contain the information about the corrected timing. Consequently, the synchronous control signals generated by the signal generator 214C may be used to notify the eyewear device 100C of the timings which are appropriately adjusted in response to operational characteristics of the light amount adjuster 161 obtained under the conditions of the environmental temperature and the voltage applied to the driver 164. The display device 200C executes step S270 after the generation of the synchronous control signals.

### (Step S270)

In step S270, the synchronous control signals generated by the signal generator 214C are transmitted from the transceiver 215C to the communication address of the eyewear device 100C. The eyewear device 100C executes step S275 after the transmission of the synchronous control signals.

### (Step S275)

In step S275, the transceiver 165C of the eyewear device 100C receives the synchronous control signals. The synchronous control signals are then output to the controller 166C. The eyewear device 100C executes step S280 after the controller 166C receives the synchronous control signals.

### (Step S280)

In step S280, the controller 166C of the eyewear device 100C controls the driver 164 of the light amount adjuster 161. Accordingly, the left adjuster 162 increases or decreases a light transmission amount to the left eye at the appropriately adjusted fluctuation timing. The right adjuster 163 increases or decreases a light transmission amount to the right eye at the appropriately adjusted fluctuation timing.

### Fifth Embodiment

### Eyewear Device

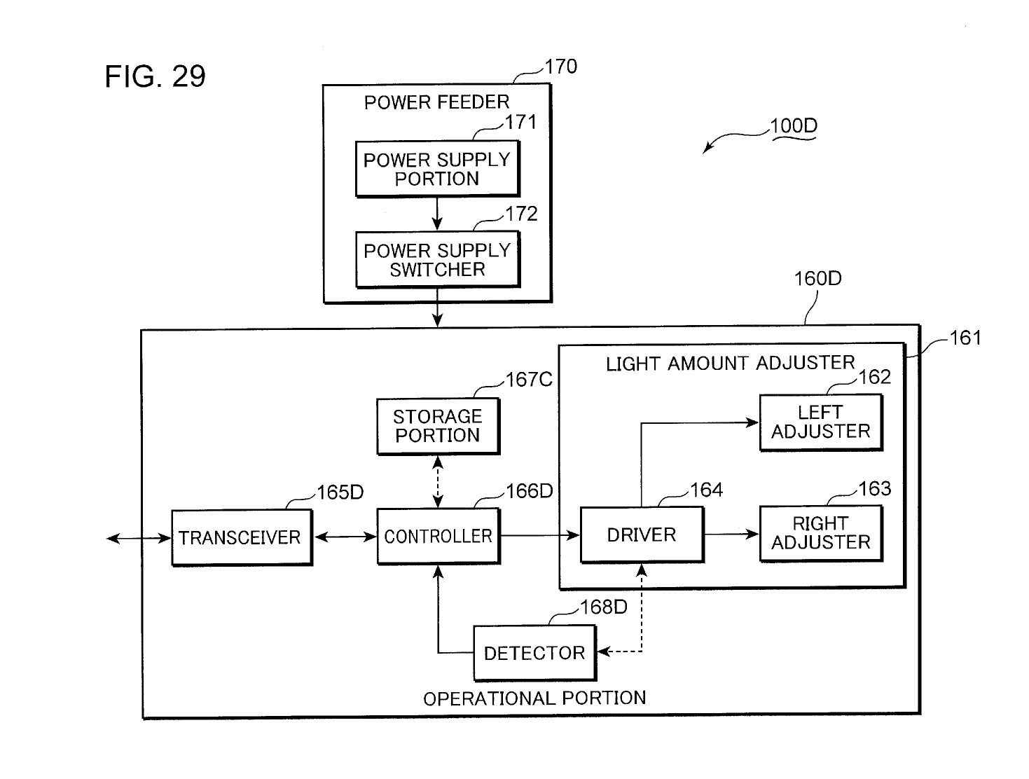

FIG. 29 is a schematic block diagram showing a functional configuration of the eyewear device 100D according to the fifth embodiment. The same reference numerals are applied to the same elements as those of the fourth embodiment. The description in the fourth embodiment is recited to describe the elements denoted by the same reference numerals. Differences between the fourth and fifth embodiments are described below.

In addition to the power feeder 170 described in the context of the fourth embodiment, the eyewear device 100D includes an operational portion 160D which is responsible for the adjustment operation to light amounts. The operational portion 160D includes the light amount adjuster 161 and the storage portion 167C, which are described in the context of the fourth embodiment.

The operational portion 160D further includes a detector 168D configured to measure a temperature of the driver 164 as an environmental temperature under which a video is observed. The detector 168D detects not only the temperature of the light amount adjuster 161 but also a voltage applied to the driver 164. In the present embodiment, the detector 168D is exemplified as the temperature detector and/or the power detector.

The operational portion 160D further includes a controller 166D configured to control the driver 164. The controller 166D uses the characteristic data stored in the storage portion 167C to generate packet signals, like the fourth embodiment. Data about the environmental temperature and data about the voltage applied to the driver 164 are output from the detector 168D to the controller 166D. The controller 166D also generates packet signals corresponding to the data output from the detector 168D.

The operational portion 160D further includes a transceiver 165D configured to transmit the packet signals. The transceiver 165D receives the synchronous control signals which contain the information about the appropriately corrected fluctuation timings, like the fourth embodiment. The transceiver 165D outputs the synchronous control signals to the controller 166D. The controller 166D controls the driver 164 in response to the synchronous control signals. Accordingly, the light amount adjuster 161 may increase or decrease a light transmission amount to the left or right eye at appropriate timings.

### (Video System)

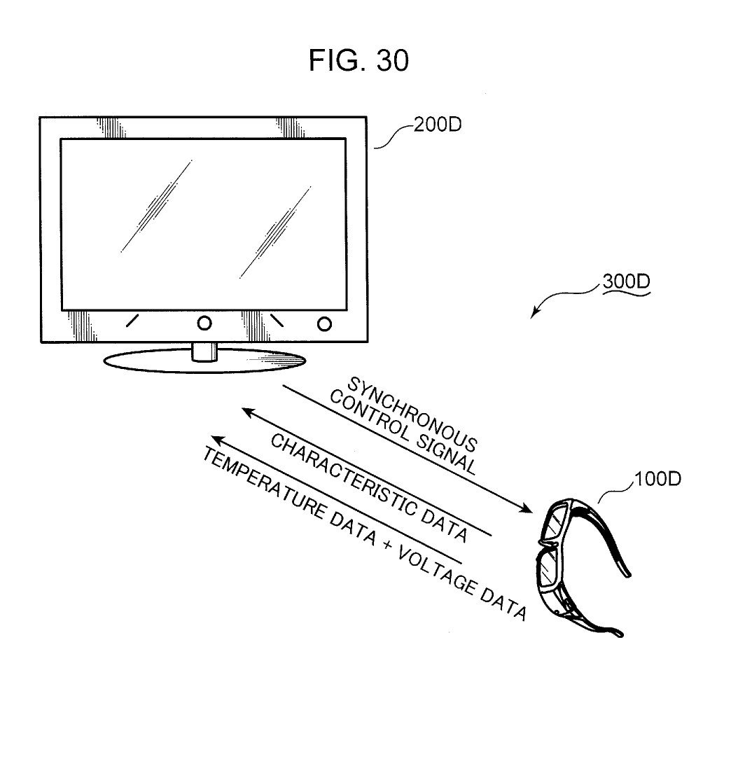

FIG. 30 is a schematic view of the video system 300D. The video system 300D is described with reference to FIGS. 29 and 30.

The video system 300D includes the eyewear device 100D and a display device 200D. Like the fourth embodiment, the eyewear device 100D transmits the characteristic data to the display device 200D. The characteristic data transmitted from the eyewear device 100D represent a relationship between the environmental temperature and the adjustment operation performed by the light amount adjuster 161 and a relationship between the voltage applied to the driver 164 and the adjustment operation performed by the light amount adjuster 161, like the fourth embodiment. Unlike the fourth embodiment, not only information (data) about the voltage but also information (data) about the environmental temperature is transmitted from the transceiver 165D of the eyewear device 100D to the display device 200D. In the present embodiment, the transceiver 165D is exemplified as the data transceiver.

### (Display Device)

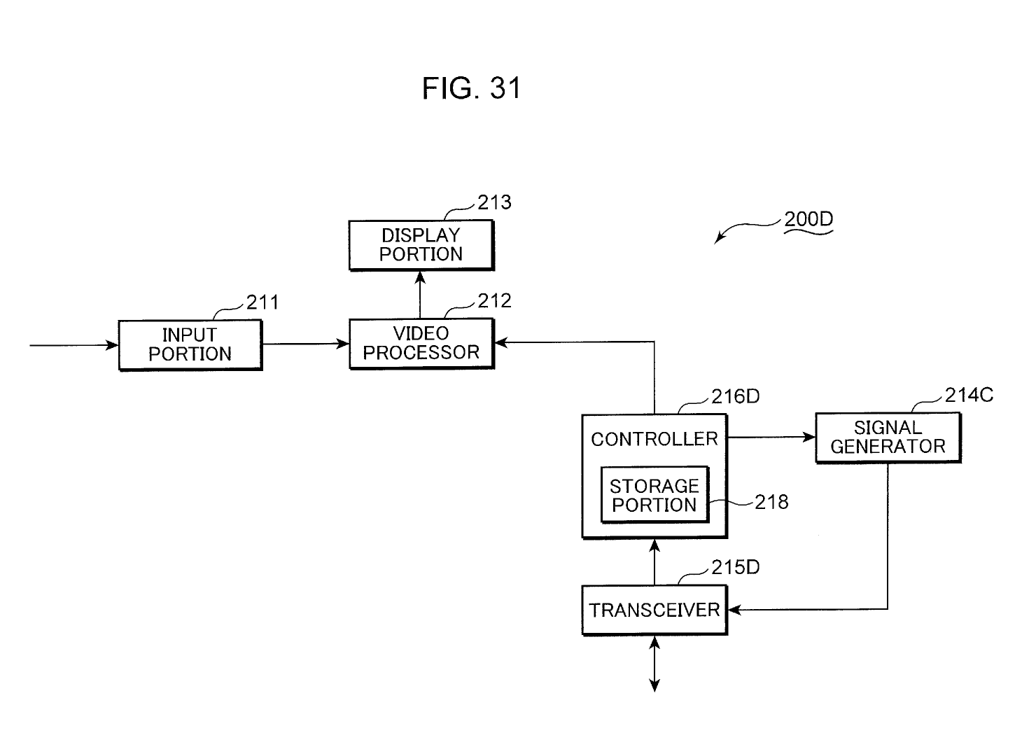

FIG. 31 is a schematic block diagram showing a functional configuration of the display device 200D. The display device 200D is described with reference to FIGS. 29 and 31.

The display device 200D includes the input portion 211, the video processor 212, the display portion 213 and the signal generator 214C, which are described in the context of the fourth embodiment. The display device 200D further includes a transceiver 215D configured to receive the packet signals generated by the eyewear device 100D. The transceiver 215D receives the packet signals containing the characteristic data, like the fourth embodiment. Unlike the fourth embodiment, the transceiver 215D receives the packet signals containing not only the information about the voltage but also the information about the environmental temperature. In the present embodiment, the transceiver 215D is exemplified as the control signal transceiver.

The display device 200D further includes a controller 216D which controls the signal generator 214C to generate the synchronous control signals. The controller 216D includes the storage portion 218, like the fourth embodiment.

The characteristic data contained in the packet signals received from the eyewear device 100D are output from the transceiver 215D to the controller 216D. The controller 216D uses the same method as the fourth embodiment to analyze the output data obtained from the transceiver 215D and reconstruct the characteristic data. The reconstructed characteristic data are stored in the storage portion 218.

Unlike the fourth embodiment, the controller 216D acquires not only the information about the voltage but also the information about the environmental temperature from the transceiver 215D. Like the fourth embodiment, the controller 216D compares the characteristic data with the information about the voltage and the information about the environmental temperature, and generates the synchronous control signals in conformity with response characteristics of the light amount adjuster 161, which are obtained under the conditions of the detected voltage and temperature.

### (Control Method of Video System)

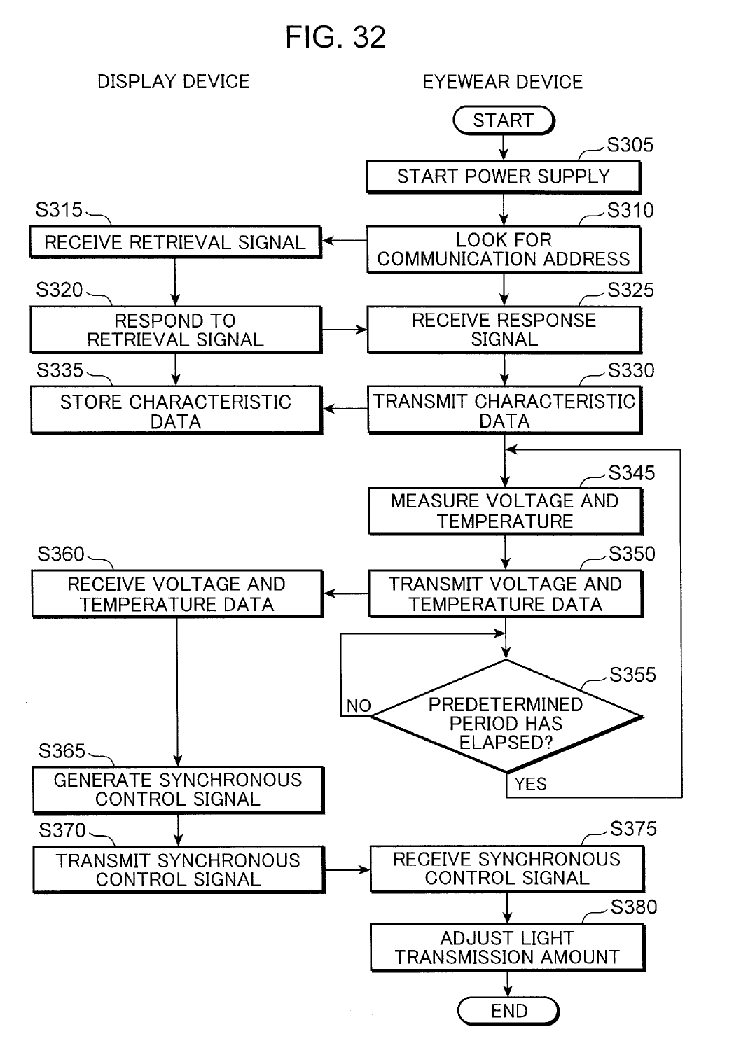

FIG. 32 is a schematic flowchart showing a control method of the video system 300D. The control method of the video system 300D is described with reference to FIGS. 29 to 32.

### (Step S305)

In step S305, the power feeder 170 of the eyewear device 100D starts power supply to the operational portion 160D. Therefore, various elements of the operational portion 160D may be activated. After the power supply to the operational portion 160D, step S310 is executed.

### (Step S310)

In step S310, in response to the power supply, the controller 166D of the eyewear device 100D generates retrieval signals to look for the display device 200D capable of communicating with the eyewear device 100D. The retrieval signal contains information about a communication address of the eyewear device 100D. The transceiver 165D of the eyewear device 100D transmits the retrieval signals. After the transmission of the retrieval signals, the display device 200D executes step S315.

### (Step S315)

In step S315, the transceiver 215D of the display device 200D receives the retrieval signals. The transceiver 215D then notifies the controller 216D of the retrieval signal reception together with information about the communication address of the eyewear device 100D. Subsequently, the display device 200D executes step S320.

### (Step S320)

In step S320, the controller 216D of the display device 200D controls the signal generator 214C to generate response signals for responding to the retrieval signal. The response signals generated by the signal generator 214C contain information about a communication address of the display device 200D. The transceiver 215D transmits the response signals to the communication address of the eyewear device 100D. After the transmission of the response signals, the eyewear device 100D executes step S325.

### (Step S325)

In step S325, the transceiver 165D of the eyewear device 100D receives the response signals. The transceiver 165D notifies the controller 166D of the response signal reception together with information about the communication address of the display device 200D. Consequently, the eyewear device 100D acquires the information about the communication address of the display device 200D whereas the display device 200D acquires the information about the communication address of the eyewear device 100D. Therefore, a radio communication channel is opened between the eyewear device 100D and the display device 200D. After the establishment of the radio communication channel, the eyewear device 100D executes step S330.

### (Step S330)

In step S330, the controller 166D of the eyewear device 100D reads the characteristic data stored in advance in the storage portion 167C. The characteristic data have been acquired individually for the eyewear device 100D by means of the measurement technologies described in the context of the first and second embodiments. Therefore, the characteristic data represent inherent response characteristics of the eyewear device 100D.

The controller 166D uses the read characteristic data to generate packet signals. The transceiver 165D transmits the generated packet signals to the communication address of the display device 200D. After the transmission of the characteristic data, the eyewear device 100D executes step S345. The display device 200D executes step S335.

### (Step S335)

In step S335, the transceiver 215D of the display device 200D receives the packet signals representing the characteristic data. Information about the characteristic data represented by the packet signals is output from the transceiver 215D to the controller 216D. The controller 216D analyzes the information output from the transceiver 215D, and reconstructs the characteristic data. The reconstructed characteristic data are stored in the storage portion 218 of the controller 216D.

### (Step S345)

In step S345, the detector 168D detects a voltage applied to the driver 164 and a temperature of the driver 164. Data about the detected voltage and data about the detected temperature are output from the detector 168D to the controller 166D. After the output of the voltage data and the temperature data, the eyewear device 100D executes step S350.

### (Step S350)

In step S350, the controller 166D uses the voltage data to generate the packet signals which contain information about the voltage applied to the driver 164 and information about the temperature of the driver 164. The packet signals are transmitted to the display device 200D through the transceiver 165D. After the transmission of the packet signals, the eyewear device 100D executes step S355 whereas the display device 200D executes step S360.

### (Step S355)

In step S355, the eyewear device 100D measures a time period after the transmission of the packet signals, which is executed in step S350. If the elapsed time period exceeds a predetermined length, step S345 is executed. If the elapsed time period is no longer than the predetermined length, step S355 is continued. Therefore, the packet signals containing the information about the voltage applied to the driver 164 and the information about the temperature of the driver 164 is periodically transmitted to the display device 200D.

### (Step S360)

In step S360, the transceiver 215D of the display device 200D receives the packet signal which contains the information about the voltage applied to the driver 164 of the eyewear device 100D and the information about the temperature of the driver 164. The information about the voltage applied to the driver 164 and the information about the temperature of the driver 164 are output from the transceiver 215D to the controller 216D. Accordingly, the controller 216D acquires the characteristic data, the information about the environmental temperature, and the information about the voltage applied to the driver 164. The display device 200D executes step S365 after the controller 216D acquires the characteristic data, the information about the environmental temperature, and the information about the voltage applied to the driver 164.

### (Step S365)

In step S365, the controller 216D determines timings, at which a light transmission amount to the left or right eye increases or decreases, on the basis of display timings defined for the video processor 212 (i.e., the start and/or end timings of frame periods). The controller 216D compares the characteristic data with the information about the environmental temperature and the information about the voltage applied to the driver 164, and corrects the timing determined on the basis of the display timings. The controller 216D causes the signal generator 214C to generate synchronous control signals which contain information about the corrected timing. Consequently, the synchronous control signals generated by the signal generator 214C may be used to notify the eyewear device 100D of the timings which are appropriately adjusted in response to operational characteristics of the light amount adjuster 161 obtained under the conditions of the environmental temperature and the voltage applied to the driver 164. The display device 200D executes step S370 after the generation of the synchronous control signals.

### (Step S370)

In step S370, the synchronous control signals generated by the signal generator 214C are transmitted from the transceiver 215D to the communication address of the eyewear device 100D. The eyewear device 100D executes step S375 after the transmission of the synchronous control signals.

### (Step S375)

In step S375, the transceiver 165D of the eyewear device 100D receives the synchronous control signals. The synchronous control signals are then output to the controller 166D. The eyewear device 100D executes step S380 after the controller 166D receives the synchronous control signals.

### (Step S380)

In step S380, the controller 166D of the eyewear device 100D controls the driver 164 of the light amount adjuster 161. Accordingly, the left adjuster 162 increases or decreases a light transmission amount to the left eye at the appropriately adjusted fluctuation timing. The right adjuster 163 increases or decreases a light transmission amount to the right eye at the appropriately adjusted fluctuation timing.

The aforementioned various embodiments are merely exemplary. Therefore, the principles of these embodiments are not limited to the aforementioned details and features shown in the drawings. It would be apparent that those skilled in the art may make various modifications, combinations or omission in the aforementioned embodiments within a scope of the principles of the embodiments.

The correction control may be executed for a period between a rising time of drive signals for driving the light amount adjuster and a time at which transmittance of the light amount adjuster increases or decreases to 50%. The correction control may be executed for a period between a rising or falling time of the synchronous control signals and a time at which transmittance of the light amount adjuster increases to 90%. Alternatively, the correction control may be executed for a period between a rising or falling time of the synchronous control signals and a time at which transmittance of the light amount adjuster decreases to 10%.

The synchronous control signals with waveforms, which rise in synchronization with the start of the left frame period and fall in synchronization with the start of the right frame period, may be used as not only a reference of the correction control but also communication signals between the display device and the eyewear device. The principles of the present embodiment should not be limited to waveforms of the synchronous control signals.

The aforementioned embodiments mainly include the following features.

The eyewear device according to one aspect of the aforementioned embodiments includes: a light amount adjuster configured to perform an adjustment operation for adjusting a fluctuation timing, at which a transmission amount of image light to the left and right eyes increases or decreases, and allowing a video to be perceived stereoscopically; a storage portion configured to store characteristic data about the adjustment operation; a receiver configured to receive a synchronous control signal which defines the fluctuation timing; and a first controller configured to control the light amount adjuster. The first controller corrects the fluctuation timing defined by the synchronous control signal, based on the characteristic data to control the adjustment operation.

According to the aforementioned configuration, the light amount adjuster executes the adjustment operation for adjusting a fluctuation timing at which a transmission amount of image light to the left and right eyes increases or decreases. Therefore, the observer may perceive a video stereoscopically.

The first controller which controls the light amount adjuster corrects the fluctuation timing defined by the synchronous control signal, which is received by the receiver, on the basis of the characteristic data stored in the storage portion. Since the fluctuation timing is corrected on the basis of the characteristic data about the adjustment operation, the observer may comfortably observe a stereoscopic video.

In the aforementioned configuration, it may be preferable that the eyewear device further includes a power supply portion configured to supply power which is used for executing the adjustment operation. The characteristic data may represent a relationship between a power amount stored in the power supply portion and an operation speed of the light amount adjuster. The first controller may determine a correction amount to the fluctuation timing in response to the power amount.

According to the aforementioned configuration, the characteristic data may represent a relationship between a power amount stored in the power supply portion and an operation speed of the light amount adjuster. The power supply portion may supply power which is used for executing the adjustment operation. Therefore, there may be a decrease in the power amount stored in the power supply portion. The first controller may determine the correction amount to the fluctuation timing in response to the power amount. Consequently, the light amount adjuster may appropriately continue to perform the adjustment operation even if the power amount decreases. Therefore, an observer may comfortably observe a stereoscopic video.

In the aforementioned configuration, it may be preferable that the characteristic data represent a relationship between an environmental temperature under which a video is observed and an operation speed of the light amount adjuster. The first controller may determine a correction amount to the fluctuation timing in response to the temperature.

According to the aforementioned configuration, the characteristic data may represent a relationship between an environmental temperature under which a video is observed and an operation speed of the light amount adjuster. The first controller may determine a correction amount to the fluctuation timing in response to the temperature. Consequently, the light amount adjuster may appropriately continue to perform the adjustment operation even under a change in a thermal environment. Therefore, an observer may comfortably observe a stereoscopic video.

In the aforementioned configuration, it may be preferable that the eyewear device further includes a power detector configured to detect the power amount.

According to the aforementioned configuration, since the power detector detects a power amount, the first controller may appropriately determine a correction amount to the fluctuation timing in response to the power amount. Thus, the light amount adjuster may appropriately continue to perform the adjustment operation even if the power amount decreases.

In the aforementioned configuration, it may be preferable that the eyewear device further includes a temperature detector configured to detect the temperature.

According to the aforementioned configuration, since the temperature detector detects a temperature, the first controller may appropriately determine a correction amount to the fluctuation timing in response to the temperature. Therefore, the light amount adjuster may appropriately continue to perform the adjustment operation even under a change in a thermal environment.

In the aforementioned configuration, it may be preferable that the characteristic data are data defined inherently for the light amount adjuster.

According to the aforementioned configuration, since the characteristic data are defined inherently for the light amount adjuster, the first controller may appropriately determine a correction amount to the fluctuation timing.

The display device according to another aspect of the aforementioned embodiments includes: a display portion configured to display a video which is perceived stereoscopically, by means of a left frame image observed by the left eye and a right frame image observed by the right eye; a second controller configured to determine display timings, at which the left and right frame images are displayed, and cause the display portion to sequentially display the left and right frame images at the display timings; and a control signal transceiver configured to transmit a synchronous control signal for notifying an eyewear device of the display timing under control of the second controller. The eyewear device performs an adjustment operation to adjust a fluctuation timing, at which a transmission amount of image light to the left and right eyes increases or decreases, and allow the video to be perceived stereoscopically. The control signal transceiver receives characteristic data about the adjustment operation from the eyewear device. The second controller controls transmission of the synchronous control signal in response to the display timings and the characteristic data.

According to the aforementioned configuration, the display portion displays a video to be perceived stereoscopically, by means of a left frame image observed by the left eye and a right frame image observed by the right eye. The second controller causes the display portion to sequentially display the left and right frame images at the display timings. The control signal transceiver transmits synchronous control signals to the eyewear device under control of the second controller, to notify the eyewear device, which performs the adjustment operation for allowing the video to be perceived stereoscopically, of the display timings at which the left and right frame images are displayed. Therefore, the eyewear device may perform the adjustment operation in response to display of the left and right frame images.

The control signal transceiver receives the characteristic data about the adjustment operation from the eyewear device. Since the second controller controls transmission of the synchronous control signals on the basis of the display timings and the characteristic data, the eyewear device may receive the synchronous control signals corresponding to the characteristic data. Therefore, the eyewear device may perform the adjustment operation appropriately in synchronization with display of the left and right frame images.

In the aforementioned configuration, it may be preferable that the synchronous control signal contains timing information about the display timing. The second controller may change the timing information in response to the characteristic data.

According to the aforementioned configuration, the synchronous control signal may contain timing information about the display timing. Since the second controller changes the timing information in response to the characteristic data, the eyewear device may receive the synchronous control signal corresponding to the characteristic data. Therefore, the eyewear device may perform the adjustment operation appropriately in synchronization with display of the left and right frame images.

In the aforementioned configuration, it may be preferable that the second controller changes transmission timing at which the synchronous control signal is transmitted, in response to the characteristic data.

According to the aforementioned configuration, since the second controller changes a transmission timing to transmit a synchronous control signal in response to the characteristic data, the eyewear device may receive the synchronous control signal at the timing corresponding to the characteristic data. Therefore, the eyewear device may perform the adjustment operation appropriately in synchronization with display of the left and right frame images.

In the aforementioned configuration, it may be preferable that the display device further includes a temperature detector configured to detect an environmental temperature under which a video is observed. The characteristic data may represent a relationship between the temperature and an operation speed of the eyewear device. The second controller may control the transmission in response to the temperature.

According to the aforementioned configuration, the characteristic data may represent a relationship between an environmental temperature under which a video is observed and an operation speed of the eyewear device. Since the second controller controls transmission of synchronous control signals in response to the environmental temperature detected by the temperature detector, the synchronous control signal corresponding to the environmental temperature may be received. Therefore, the eyewear device may appropriately perform the adjustment operation in synchronization with display of the left and right frame images even under a change in a thermal environment.

The video system according to another aspect of the aforementioned embodiments includes: an eyewear device configured to perform an adjustment operation for adjusting a fluctuation timing, at which a transmission amount of image light to the left and right eyes increases or decreases, and allowing a video to be perceived stereoscopically; and a display device configured to display the video by means of a left frame image observed by the left eye and a right frame image observed by the right eye. The display device includes a transmitter configured to transmit a synchronous control signal which defines the fluctuation timing. The eyewear device includes: a light amount adjuster configured to perform the adjustment operation; a storage portion configured to store characteristic data about the adjustment operation; a receiver configured to receive the synchronous control signal; and a first controller configured to control the light amount adjuster. The first controller corrects the fluctuation timing defined by the synchronous control signal based on the characteristic data to control the adjustment operation.

According to the aforementioned configuration, the display device displays a stereoscopic video by means of a left frame image observed by the left eye and a right frame image observed by the right eye. The eyewear device adjusts a fluctuation timing, at which a transmission amount of image light to the left and right eyes increases or decreases, and performs the adjustment operation for allowing the video to be perceived stereoscopically. Therefore, an observer may perceive the video stereoscopically.

The transmitter of the display device transmits a synchronous control signal which defines the fluctuation timing. The receiver of the eyewear device receives the synchronous control signal. The first controller, which controls the light amount adjuster executing the adjustment operation, corrects the fluctuation timing defined by the synchronous control signal, which is received by the receiver, on the basis of the characteristic data stored in the storage portion. Since the fluctuation timing is corrected on the basis of the characteristic data about the adjustment operation, the observer may comfortably observe the stereoscopic image.

The video system according to yet another aspect of the aforementioned embodiments includes: an eyewear device configured to perform an adjustment operation for adjusting a fluctuation timing, at which a transmission amount of image light to the left and right eyes increases or decreases, and allowing a video to be perceived stereoscopically; and a display device configured to display the video by means of a left frame image observed by the left eye and a right frame image observed by the right eye. The eyewear device includes: a light amount adjuster configured to execute the adjustment operation; a storage portion configured to store characteristic data about the adjustment operation; a data transceiver configured to transmit the characteristic data to the display device; and a first controller configured to control the light amount adjuster. The display device includes: a display portion configured to display the video; a second controller configured to determine display timings, at which the left and right frame images are displayed, and cause the display portion to sequentially display the left and right frame images at the display timings; and a control signal transceiver configured to receive the characteristic data and transmit a synchronous control signal for notifying the data transceiver of the display timings under control of the second controller. The second controller controls transmission of the synchronous control signal, based on the display timings and the characteristic data. The first controller controls the light amount adjuster in response to the synchronous control signal.

According to the aforementioned configuration, the display device displays a stereoscopic video by means of a left frame image observed by the left eye and a right frame image observed by the right eye. The eyewear device adjusts a fluctuation timing, at which a transmission amount of image light to the left and right eyes increases or decreases, and performs the adjustment operation for allowing the video to be perceived stereoscopically. Therefore, the observer may stereoscopically perceive the video.

The storage portion stores characteristic data about the adjustment operation executed by the light amount adjuster. The data transceiver transmits the characteristic data to the display device. The control signal transceiver of the display device receives the characteristic data. Consequently, the characteristic data of the eyewear device are transmitted to the display device.

The second controller of the display device determines display timings to display the left and right frame images. The display portion sequentially displays the left and right frame images at the display timings under control of the second controller. Consequently, the observer may stereoscopically perceive the video displayed by the display portion.

The control signal transceiver of the display device transmits synchronous control signals to the data transceiver of the eyewear device under control of the second controller. Consequently, the eyewear device is notified of the display timings.

Since the second controller of the display device controls transmission of the synchronous control signals on the basis of the display timings and the characteristic data, the first controller of the eyewear device may appropriately control the light amount adjuster in response to the synchronous control signal. Therefore, the eyewear device may execute the adjustment operation appropriately in synchronization with display of the left and right frame images.

In the aforementioned configuration, it may be preferable that the eyewear device includes a power supply portion configured to supply power, which is used for executing the adjustment operation, and a power detector configured to detect a power amount stored in the power supply portion. The characteristic data may represent a relationship between the power amount stored in the power supply portion and an operation speed of the light amount adjuster. The data transceiver may transmit power information about the power amount to the control signal transceiver after the characteristic data are transmitted. The second controller may compare the power information with the characteristic data to control the transmission of the synchronous control signal.

According to the aforementioned configuration, the characteristic data may represent a relationship between a power amount stored in the power supply portion and an operation speed of the light amount adjuster. The power amount stored in the power supply portion decreases as the power supply portion supplies the power used for execution of the adjustment operation. After transmission of the characteristic data representing the relationship between the power amount stored in the power supply portion and the operation speed of the light amount adjuster, the data transceiver may transmit the power information about the power amount to the control signal transceiver. Consequently, both the characteristic data of the eyewear device and the power information are transmitted to the display device. Since the second controller of the display device compares the power information with the characteristic data to control the transmission of the synchronous control signal, the light amount adjuster may continue to perform the adjustment operation appropriately even if the power amount decreases.

In the aforementioned configuration, it may be preferable that the eyewear device includes a temperature detector configured to detect an environmental temperature under which a video is observed. The characteristic data may represent a relationship between the temperature and an operation speed of the light amount adjuster. The data transceiver may transmit temperature information about the temperature to the control signal transceiver after the characteristic data are transmitted. The second controller may compare the temperature information with the characteristic data to control the transmission of the synchronous control signal.

According to the aforementioned configuration, after the transmission of the characteristic data, which represent a relationship between an environmental temperature under which a video is observed and an operation speed of the light amount adjuster, information about the temperature, which is detected by the temperature detector, is transmitted from the data transceiver to the control signal transceiver. Consequently, the characteristic data of the eyewear device and the temperature information are transmitted to the display device. Since the second controller of the display device compares the temperature information with the characteristic data to control the transmission of the synchronous control signal, the light amount adjuster may continue to perform the adjustment operation appropriately even under a change in a thermal environment.

The control method according to yet another aspect of the aforementioned embodiments is applied to an eyewear device which performs an adjustment operation for adjusting a fluctuation timing, at which a transmission amount of image light to the left and right eyes increases or decreases, and allowing a video to be perceived stereoscopically. The control method includes steps of: receiving a synchronous control signal which defines the fluctuation timing; and correcting the fluctuation timing defined by the synchronous control signal, based on characteristic data about the adjustment operation, to control the adjustment operation.

According to the aforementioned configuration, the eyewear device receives synchronous control signals, which define fluctuation timings to increase or decrease a transmission amount of image light to the left and right eyes, in order to perform the adjustment operation for adjusting the fluctuation timing and allow a video to be perceived stereoscopically. The eyewear device then corrects the fluctuation timing defined by the synchronous control signal, by means of characteristic data about the adjustment operation. Therefore, the eyewear device may appropriately control the adjustment operation.

The control method according to yet another aspect of the aforementioned embodiments is applied to a video system, which includes an eyewear device configured to perform an adjustment operation for adjusting a fluctuation timing, at which a transmission amount of image light to the left and right eyes increases or decreases, and allowing a video to be perceived stereoscopically, and a display device configured to display the video by means of a left frame image observed by the left eye and a right frame image observed by the right eye. The control method includes steps of: transmitting characteristic data about the adjustment operation from the eyewear device to the display device; determining display timings at which the left and right frame images are displayed; controlling transmission of a synchronous control signal for notifying the eyewear device of the display timing, based on the display timings and the characteristic data; and adjusting the fluctuation timing in response to the synchronous control signal.

According to the aforementioned configuration, the display device displays a stereoscopic video by means of a left frame image observed by the left eye and a right frame image observed by the right eye. The eyewear device performs the adjustment operation for adjusting a fluctuation timing of increase or decrease a transmission amount of image light to the left and right eyes, in order to allow the video to be perceived stereoscopically. Therefore, an observer may perceive the video stereoscopically.

The characteristic data about the adjustment operation are transmitted from the eyewear device to the display device. Thus, the display device may acquire the characteristic data. Since the transmission of the synchronous control signal is controlled on the basis of display timings, at which the left and right frame images are displayed, and the characteristic data, the eyewear device is notified of the display timing corresponding to the characteristic data. Therefore, the eyewear device may appropriately control the adjustment operation.

### INDUSTRIAL APPLICABILITY

The principles of the aforementioned embodiments are suitably used for video technologies which allow an observer to view a video under assistance of an eyewear device.

1. An eyewear device, comprising:
a light amount adjuster configured to perform an adjustment operation for adjusting a fluctuation timing, at which a transmission amount of image light to a left eye and a right eye increases or decreases, and allowing a video to be perceived stereoscopically;
a storage portion configured to store characteristic data about the adjustment operation;
a receiver configured to receive a synchronous control signal which defines the fluctuation timing; and
a first controller configured to control the light amount adjuster,
wherein the first controller corrects the fluctuation timing defined by the synchronous control signal, based on the characteristic data to control the adjustment operation.

2. The eyewear device according to claim 1, further comprising:
a power supply portion configured to supply power which is used for executing the adjustment operation, wherein
the characteristic data represent a relationship between a power amount stored in the power supply portion and an operation speed of the light amount adjuster, and
the first controller determines a correction amount to the fluctuation timing in response to the power amount.

3. The eyewear device according to claim 1, wherein
the characteristic data represent a relationship between an environmental temperature under which the video is observed and an operation speed of the light amount adjuster, and
the first controller determines a correction amount to the fluctuation timing in response to the temperature.

4. The eyewear device according to claim 2, further comprising a power detector configured to detect the power amount.

5. The eyewear device according to claim 3, further comprising a temperature detector configured to detect the temperature.

6. The eyewear device according to claim 1, wherein the characteristic data are data defined inherently for the light amount adjuster.

7. A display device, comprising:
a display portion configured to display a video which is perceived stereoscopically, by means of a left frame image observed by a left eye and a right frame image observed by a right eye;
a second controller configured to determine display timings, at which the left and right frame images are displayed, and cause the display portion to sequentially display the left and right frame images at the display timings; and
a control signal transceiver configured to transmit a synchronous control signal for notifying an eyewear device of the display timing under control of the second controller, the eyewear device performing an adjustment operation for adjusting a fluctuation timing, at which a transmission amount of image light to the left and right eyes increases or decreases, and allowing the video to be perceived stereoscopically, wherein
the control signal transceiver receives characteristic data about the adjustment operation from the eyewear device, and
the second controller controls transmission of the synchronous control signal in response to the display timings and the characteristic data.

8. The display device according to claim 7, wherein
the synchronous control signal contains timing information about the display timing, and
the second controller changes the timing information in response to the characteristic data.

9. The display device according to claim 7, wherein the second controller changes transmission timing at which the synchronous control signal is transmitted, in response to the characteristic data.

10. The display device according to claim 7, further comprising:
a temperature detector configured to detect an environmental temperature under which the video is observed, wherein
the characteristic data represent a relationship between the temperature and an operation speed of the eyewear device, and
the second controller controls the transmission in response to the temperature.

11. A video system, comprising:
an eyewear device configured to perform an adjustment operation for adjusting a fluctuation timing, at which a transmission amount of image light to a left eye and a right eye increases or decreases, and allowing a video to be perceived stereoscopically; and
a display device configured to display the video by means of a left frame image observed by the left eye and a right frame image observed by the right eye, wherein
the display device includes a transmitter configured to transmit a synchronous control signal which defines the fluctuation timing, and
the eyewear device includes:
a light amount adjuster configured to perform the adjustment operation;
a storage portion configured to store characteristic data about the adjustment operation;
a receiver configured to receive the synchronous control signal; and
a first controller configured to control the light amount adjuster,
the first controller corrects the fluctuation timing defined by the synchronous control signal based on the characteristic data to control the adjustment operation.

12. A video system, comprising:
an eyewear device configured to perform an adjustment operation for adjusting a fluctuation timing, at which a transmission amount of image light to a left eye and a right eye increases or decreases, and allowing a video to be perceived stereoscopically; and
a display device configured to display the video by means of a left frame image observed by the left eye and a right frame image observed by the right eye, wherein
the eyewear device includes:
a light amount adjuster configured to execute the adjustment operation;
a storage portion configured to store characteristic data about the adjustment operation;
a data transceiver configured to transmit the characteristic data to the display device; and
a first controller configured to control the light amount adjuster, and
the display device includes:
a display portion configured to display the video;
a second controller configured to determine display timings, at which the left and right frame images are displayed, and cause the display portion to sequentially display the left and right frame images at the display timings; and
a control signal transceiver configured to receive the characteristic data and transmit a synchronous control signal for notifying the data transceiver of the display timings under control of the second controller,
the second controller controls transmission of the synchronous control signal, based on the display timings and the characteristic data, and
the first controller controls the light amount adjuster in response to the synchronous control signal.

13. The video system according to claim 11, wherein
the eyewear device includes a power supply portion configured to supply power, which is used for executing the adjustment operation, and a power detector configured to detect a power amount stored in the power supply portion,
the characteristic data represent a relationship between the power amount stored in the power supply portion and an operation speed of the light amount adjuster,
the data transceiver transmits power information about the power amount to the control signal transceiver after the characteristic data are transmitted, and
the second controller compares the power information with the characteristic data to control the transmission of the synchronous control signal.

14. The video system according to claim 11, wherein
the eyewear device includes a temperature detector configured to detect an environmental temperature under which the video is observed,
the characteristic data represent a relationship between the temperature and an operation speed of the light amount adjuster,
the data transceiver transmits temperature information about the temperature to the control signal transceiver after the characteristic data are transmitted, and
the second controller compares the temperature information with the characteristic data to control the transmission of the synchronous control signal.

15. A control method of an eyewear device configured to perform an adjustment operation for adjusting a fluctuation timing, at which a transmission amount of image light to a left eye and a right eye increases or decreases, and allowing a video to be perceived stereoscopically, the control method comprising:
receiving a synchronous control signal which defines the fluctuation timing; and
correcting the fluctuation timing defined by the synchronous control signal, based on characteristic data about the adjustment operation, to control the adjustment operation.

16. A control method of a video system including an eyewear device configured to perform an adjustment operation for adjusting a fluctuation timing, at which a transmission amount of image light to a left eye and a right eye increases or decreases, and allowing a video to be perceived stereoscopically, and a display device configured to display the video by means of a left frame image observed by the left eye and a right frame image observed by the right eye, the control method comprising:
transmitting characteristic data about the adjustment operation from the eyewear device to the display device;
determining display timings at which the left and right frame images are displayed;
controlling transmission of a synchronous control signal for notifying the eyewear device of the display timing, based on the display timings and the characteristic data; and
adjusting the fluctuation timing in response to the synchronous control signal.
